(19) United States
(12) Patent Application Publication
(10) Pub. No.: US 2025/0174374 A1
(43) Pub. Date: May 29, 2025

(54) CABLING APPARATUSES AND SYSTEMS WITH LOW VOLTAGE DIGITAL CONNECTIVITY

(71) Applicant: PCC Integrate Inc., Calgary (CA)

(72) Inventors: Peter CRAWLEY, Calgary (CA); Lynda WHITE-CRAWLEY, Calgary (CA); Stuart CRAWLEY, Calgary (CA); Gavin CRAWLEY, Calgary (CA)

(21) Appl. No.: 18/606,488

(22) Filed: Mar. 15, 2024

Related U.S. Application Data
(63) Continuation of application No. PCT/CA23/51576, filed on Nov. 24, 2023.

(51) Int. Cl. H01B 11/12; H01R 13/639; H01R 13/6463; H01R 13/74; H01R 24/64

(52) U.S. Cl. CPC H01B 11/125; H01R 13/639; H01R 13/6463; H01R 13/74; H01R 24/64

(57) ABSTRACT

An apparatus has a flexible elongated body, a plurality of cables extending in the body along a lengthwise direction, and a first connection assembly on a longitudinally first end of the body connecting to the plurality of cables. Each of the plurality of cables comprises a plurality of wires for transmitting signals and/or power to the first connection assembly.

### CROSS-REFERENCE TO RELATED APPLICATIONS

This application is a bypass continuation of Patent Cooperation Treaty International Application Ser No. PCT/CA2023/051576, filed Nov. 24, 2023, the content of which is incorporated herein by reference in its entirety.

### TECHNICAL FIELD

The present disclosure relates generally to cabling apparatuses and systems and in particular to cabling apparatuses and systems with low voltage digital connectivity.

### BACKGROUND

Smart buildings are the foundation of smart cities. A smart building generally comprises a centralized, automatic control system such as a building management system (BMS) for controlling various functions of a building such as heating, ventilation, and air conditioning (HVAC), electrical, lighting, alarm, access control, security, and/or the like, to deliver efficiencies of operation and usability.

A smart building, and in particular a business or enterprise smart-building often requires numerous cables of various types. Design, installation, management, maintenance, and repairing of the cables generally put a huge burden to operators.

### SUMMARY

According to one aspect of this disclosure, there is provided an apparatus comprising: a first flexible elongated body; a plurality of cables extending in the first body along a lengthwise direction; and a first connection assembly on a longitudinally first end of the first body connecting to the plurality of cables; each of the plurality of cables comprises a plurality of wires for transmitting signals and/or power to the first connection assembly.

In some embodiments, the first connection assembly comprises: a first housing; and a plurality of first ports at fixed locations on or adjacent a distal end of the first housing; each first port of the plurality of first ports comprises a plurality of pins connecting to the plurality of wires of the cable that the first port is connected thereto.

In some embodiments, each of the plurality of pins is an end portion of the corresponding wire.

In some embodiments, the plurality of first ports are registered-jack-45 (RJ45) ports.

In some embodiments, the plurality of cables are category (CAT) 5, CAT 5e, CAT6, CAT 6A, CAT 6e, CAT 7, and/or CAT 8 cables.

In some embodiments, the plurality of first ports are arranged in a matrix form.

In some embodiments, the connection assembly comprises an indication for indicating the plurality of first ports.

In some embodiments, the indication comprises one or more of a predefined order of the plurality of first ports, one or more colors, and one or more numbers.

In some embodiments, each of the plurality of cables comprises: a flexible, elongated jacket; and a noise-reduction shield received in the jacket; the plurality of wires are received in the shield.

In some embodiments, the plurality of wires are arranged in a plurality of wire pairs.

In some embodiments, of the plurality of cables comprises a filler for separating the plurality of wire pairs.

In some embodiments, the apparatus further comprises: a second connection assembly on a longitudinally second end of the first body connecting to the plurality of cables, the second end being longitudinally opposite to the first end; the plurality of wires of each of the plurality of cables are for transmitting signals and/or power between the first and second connection assemblies.

In some embodiments, the second connection assembly comprises: a second housing; and a plurality of second ports at fixed locations on or adjacent a distal end of the second housing; each second port of the plurality of second ports comprises a plurality of pins connecting to the plurality of wires of the cable that the second port is connected thereto.

In some embodiments, the second connection assembly comprises: a second housing; and a plurality of pin holes at fixed locations on or adjacent a distal end of the second housing; each of the plurality of pin holes comprises an electrically conductive pin sleeve received therein and connecting to one of the plurality of wires of the plurality of cables.

According to one aspect of this disclosure, there is provided a panel comprising: a plurality of ports arranged in groups for connecting a group of connection ports to one of the first and second connection assemblies of the above-described apparatus.

In some embodiments, a distance between neighboring groups is greater than a distance between neighboring connection ports.

According to one aspect of this disclosure, there is provided a cable system comprising: a plurality of the above-described apparatuses deployed in a site.

In some embodiments, the cable system further comprises: one or more panels of any one of claims 15 to 16 each for connecting one or more of the plurality of the apparatuses.

In some embodiments, the cable system further comprises: a component cable assembly comprising: a second elongated flexible body, and a pair of connectors coupled to two opposite ends of the second body; the second body has same electrical specifications as those of the first body, except length-related electrical specifications.

In some embodiments, the pair of connectors comprise a female RJ45 connector and a male RJ45 connector.

In some embodiments, the electrical specifications comprise: number and specifications of wires in the second body; manner of twisting of the wires in the second body; and noise-reduction shield in the second body.

In some embodiments, the second body has same mechanical specifications as those of the first body, except length-related mechanical specifications.

According to one aspect of this disclosure, there is provided a cable-pulling sled comprising: a head housing; and a retention strap extending rearwardly from the head housing; the head housing comprises: a base, a wall extending upwardly along the peripheral of the base, and a plurality of tie-downs extending upwardly from the base for retaining a plurality of cabling apparatuses to the base; and the plurality of tie-downs are at locations of the base such that head connectors of the plurality of cabling apparatuses are arranged in a zig-zag manner on the base.

In some embodiments, the cable-pulling sled further comprises: a handle extends forwardly from a front portion of the wall.

In some embodiments, the handle comprises a hole.

In some embodiments, the retention strap comprises a plurality of strings for securing plurality of cabling apparatuses to the retention strap.

According to one aspect of this disclosure, there is provided a computerized method for deployment of a cabling system in a site, the method comprising: collecting information related to the deployment of the cabling system in the site; defining a scope of a project for the deployment of the cabling system in the site; cross-referencing the scope of the project with information obtained from a design database; using an artificial intelligence (AI) engine linked to the design database to design the cabling system based on the defined scope of the project and the cross-referencing; plotting the cabling system onto floor plans of the site to produce one or more drawings; creating a bill of materials showing components of the cabling system and their details; receiving quotes related to the bill of materials; generating a set of deployment documentation for the cabling system, the deployment documentation comprising a deployment plan for the project; and reviewing and verifying the cabling system and the project using data obtained from the design database, the bill of materials, and the deployment documentation, for starting the project for the deployment of the cabling system in the site.

In some embodiments, the AI engine is a machine-learning engine.

In some embodiments, the scope of the project comprises tray routes, site conditions that need to be considered, and key deliverable dates.

In some embodiments, the cabling system is an optimized system in compliance with one or more government-regulated cabling-system codes and/or one or more cabling-system standards.

In some embodiments, the design database stores the one or more government-regulated cabling-system codes, the one or more cabling-system standards, and/or data of previously designed cabling systems.

In some embodiments, the computerized method further comprises: determining one or more infractions of the cabling system; and providing options for resolution of the one or more infractions based on information obtained from the design database.

In some embodiments, the one or more infractions comprise: cable lengths that do not meet a maximum end-to-end data run; one or more conflicts with other services; and fill density of physical infrastructure.

In some embodiments, the computerized method further comprises: storing the cabling system and/or the one or more drawings in the design database.

In some embodiments, the computerized method further comprises: tracking changes made to the cabling system and the project; determining if a cost is associated with the changes; and revising the cabling system and the project.

In some embodiments, said reviewing and verifying the cabling system and the project comprises: confirming accuracy of the drawings and the deployment plan.

In some embodiments, said confirming the accuracy of the drawings and the deployment plan comprises the confirmation of: all orders being received correctly; deployment of components of the cabling system following parameters of the cabling system; and information of the cabling system and the project being available to one or more first users.

In some embodiments, the computerized method further comprises: receiving validation from a second user.

In some embodiments, the computerized method further comprises: receiving signoff from one or more third users.

In some embodiments, the computerized method further comprises: receiving as-builts, said as-builts showing deviations occurred in the deployment of the cabling system; and/or receiving test results of the of the cabling system.

In some embodiments, the computerized method further comprises: compiling dates and schedules for maintenance of the cabling system.

In some embodiments, the computerized method further comprises: compiling a customer relationship management (CRM) report of the cabling system and the deployment of the cabling system.

In some embodiments, the computerized method further comprises: providing a virtual reality (VR) model and/or a three-dimensional (3D) model.

According to one aspect of this disclosure, there is provided a system comprising: one or more memory units; and one or more processors functionally coupling to the one or more memory units for automatically performing the above-described method.

According to one aspect of this disclosure, there is provided one or more non-transitory computer-readable storage media comprising computer-executable instructions, wherein the instructions, when executed, cause one or more processors to perform the above-described method.

### BRIEF DESCRIPTION OF THE DRAWINGS

For a more complete understanding of the disclosure, reference is made to the following description and accompanying drawings, in which:

FIG. 1 is a schematic diagram of a building with deployment of a building management system (BMS), according to some embodiments of this disclosure;

FIG. 2 is a schematic diagram showing the technologies used by the devices and/or systems deployed in the building shown in FIG. 1, wherein the technologies may be classified into operational technologies (OT) and information technologies (IT) with convergence thereof;

FIG. 3 is a schematic diagram showing the smart-building applications used in the building shown in FIG. 1;

FIG. 4 is a schematic diagram showing a conventional cabling system for the BMS shown in FIG. 1, wherein cabling system uses the point-to-point connection method for providing interconnectivity to devices, systems, and/or applications used in the building shown in FIG. 1;

FIG. 5 is a schematic diagram showing a cabling system for the BMS shown in FIG. 1, according to the ANSI/BICSI 007-2020 standard;

FIG. 6 is a schematic diagram showing a testing configuration of the cabling system shown in FIG. 5;

FIG. 7 is a schematic diagram showing a cabling system for the BMS shown in FIG. 1, according to some embodiments of this disclosure;

FIG. 8 is a schematic diagram showing a loom cable assembly of the cabling system shown in FIG. 7, according to some embodiments of this disclosure, wherein the loom cable assembly comprises a flexible, elongated body with a head assembly and a hub assembly on longitudinally opposite ends thereof;

FIG. 9 is a schematic cross-sectional view of the body of the loom cable assembly shown in FIG. 8, wherein the body receives therein a plurality of cables;

FIG. 10A is a schematic cross-sectional view of a category (CAT) 6A cable in the body shown in FIG. 9;

FIG. 10B is a schematic cross-sectional view of a category (CAT) 6 cable in the body shown in FIG. 9;

FIGS. 11A to 11D are plan view, front view, side view, and schematic perspective view of the head assembly of the loom cable assembly shown in FIG. 8, respectively;

FIGS. 12A to 12C are plan view, front view, and side view of the hub assembly of the loom cable assembly shown in FIG. 8, respectively;

FIG. 13 is a schematic cross-sectional view of the head assemblies of two loom cable assemblies shown in FIG. 8 mounted to a standard plenum or under-floor cable tray;

FIG. 14 is a schematic cross-sectional view of a patch panel of the cabling system shown in FIG. 7, according to some embodiments of this disclosure;

FIGS. 15A to 15C are schematic plan view, side view, and front view, respectively, of a cable-pulling sled for pulling a plurality of loom cable assemblies shown in FIG. 8;

FIG. 15D is a schematic plan view showing the cable-pulling sled shown in FIGS. 15A to 15C with four loom cable assemblies shown in FIG. 8 secured thereto;

FIG. 16 is a schematic perspective view of a component cable for use with the loom cable assembly shown in FIG. 8, according to some embodiments of this disclosure;

FIG. 17A is a schematic perspective view of a hub assembly of the loom cable assembly shown in FIG. 8, according to some embodiments of this disclosure;

FIG. 17B is a schematic diagram showing a cabling system for the BMS shown in FIG. 1, according to some embodiments of this disclosure, wherein the cabling system employs one or more loom cable assemblies shown in FIG. 17A;

FIG. 18 is a schematic diagram showing a cabling system for the BMS shown in FIG. 1, according to some embodiments of this disclosure;

FIG. 19A is a schematic diagram of a cabling design system in the form of a computer network system for cabling design, according to some embodiments of the present disclosure;

FIG. 19B is a schematic diagram showing a simplified hardware structure of a computing device of the cabling design system shown in FIG. 19A;

FIG. 19C is a schematic diagram showing a simplified software architecture of a computing device of the cabling design system shown in FIG. 19A;

FIG. 20 is a schematic diagram showing the architecture modules of the cabling design system shown in FIG. 19A, according to some embodiments of the present disclosure;

FIG. 21 is a schematic diagram showing the functions of the cabling design system shown in FIG. 19A, according to some embodiments of the present disclosure; and

FIG. 22 is a schematic diagram showing an exemplary implementation of the functions shown in FIG. 21, according to some embodiments of the present disclosure

### DETAILED DESCRIPTION

Embodiments herein disclose a next generation of SMART zonal cabling systems for all data, communications, and control solutions for SMART buildings. This will address the current problem of inefficient and costly layering of technologies and mixed media cabling.

### A. Building Management System and Cabling System

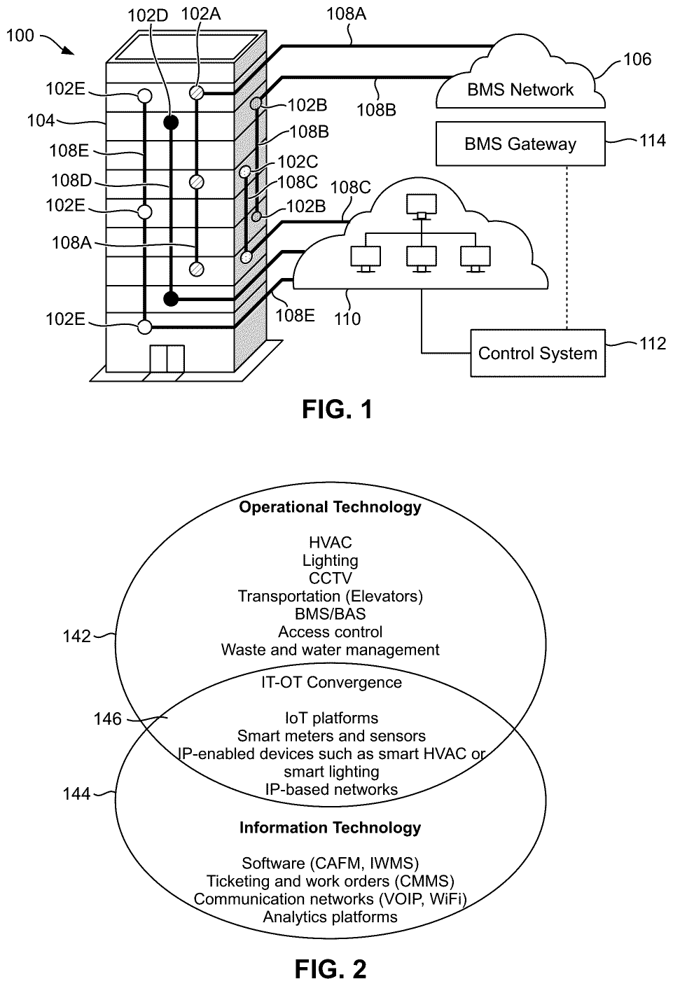

Turning now to FIG. 1, a building management system (BMS) in some embodiments is shown and is generally identified using reference numeral 100. As shown, the BMS 100 generally comprises a plurality of devices 102 deployed in the building 104. Examples of the function devices and/or systems 102 include lighting devices 102A for lighting various locations in the building 104, heating, ventilation, and air conditioning (HVAC) devices 102B for providing heating, ventilation, and air conditioning to the building 104, power devices 102C for providing power to the devices in the building 104, audio/video (AV) devices 102D for providing AV streams to various locations of the building 104, and closed-circuit cameras 102E (also called “closed-circuit television (CCTV) devices”) deployed at various locations of the building 104 for monitoring and security.

A BMS network 106 is connected to some devices and/or systems such as the lighting devices 102A and the HVAC devices 102B via a plurality of respective cables 108A and 108B for managing and controlling the building operation. A local area network (LAN) 110 is connected to some devices such as the power devices 102C, the AV devices 102D, and the closed-circuit cameras 102E via a plurality of respective cables 108C, 108D, and 108E. A control system 112 is connected to the BMS network 106 (via a BMS gateway 114) and the LAN 110 for managing and controlling the devices 102 deployed in the building 104.

As shown in FIG. 2, the technologies used by the devices 102 may be classified into operational technologies (OT) 142 and information technologies (IT) 144. Examples of OT 142 may be HVAC, lighting, CCTV, transportation (such as elevators), BMS and/or building automation system (BAS), access control, waste and water management, and/or the like. Examples of IT 144 may be software (such as computer aided facility management (CAFM) software, integrated workplace management system (IWMS) software), ticketing and work orders (such as computerized maintenance management system (CMMS) software), communication networks (such as voice over Internet protocol (VOIP), WI-FI© (WI-FI is a registered trademark of Wi-Fi Alliance, Austin, TX, USA)), analytics platforms, and/or the like.

With the advance of technologies, OT 142 and IT 144 are converging. FIG. 2 also shows the IT-OT convergence technologies 146 such as Internet-of-things (IoT) technologies, smart meters and sensors, IP-enabled devices such as smart HVAC or smart lighting, IP-based networks, and/or the like. The convergence of OT 142 and IT 144 and the use of IoT technologies make buildings 104 smarter, more efficient, and easier to manage.

Using the IT-OT convergence technologies 146 and IoT technologies for making a “smart” or “intelligent” requires great interconnectivity between various devices 102. For example, Internet protocol (IP) based connectivity provides an exceptional level of control. Occupants and building managers may control workspace lighting via their own smart device, thereby creating an environment most conducive to each individual. Ease and efficiency of installation is also a benefit, as data and power are delivered via the same low-voltage Ethernet cable, thereby eliminating the need for an electrician and additional wiring.

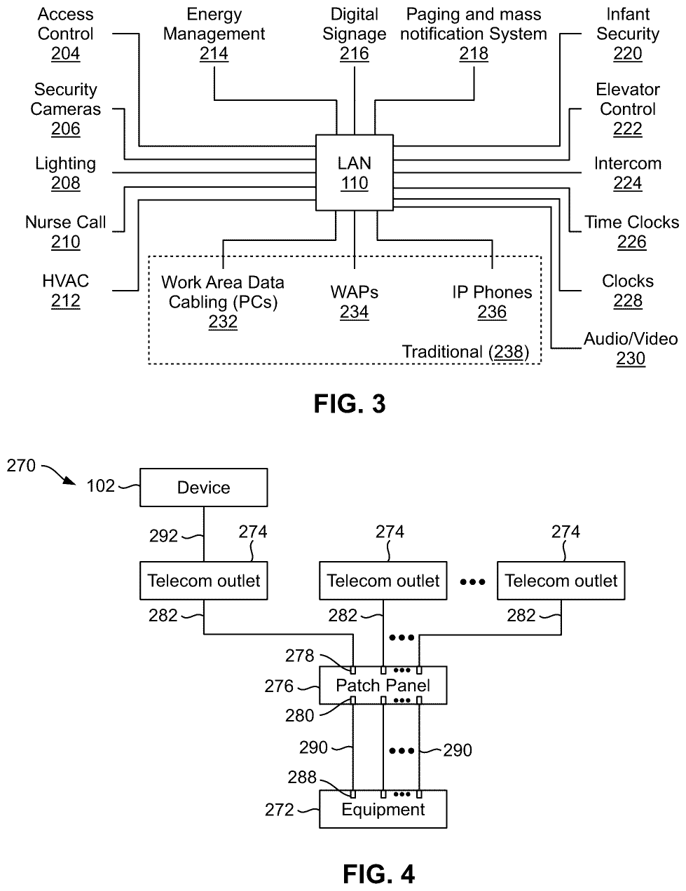

FIG. 3 shows an example of smart-building applications that are now digital with support on IP networks. As shown, such applications may include access control 204, security cameras 206, lighting 208, nurse call 210, HVAC 212, energy management 214, digital signage 216, paging and mass notification system 218, infant security 220, elevator control 222, intercom 224, time clocks 226 (that is, electronic zonal displays that are network linked), IP driven clocks 228, AV system 230, work area data cabling 232 (for example, for use by computers (such as personal computers (PCs) and/or servers) and/or other computing devices), wireless access points (WAPs) 234, IP phones 236, and/or the like, all connected to the LAN 110. In this example, the work area data cabling 232, WAPs 234, and IP phones 236 are traditional IP-based applications 238 (that is, IT-technology devices).

The BMS 100 generally requires a cabling system to be deployed in the building 104 for adapting to various requirements such as the maximum cable length (for example, about 100 meters (m) (or 328 feet (ft)) for category (CAT) 5e and CAT 6 cables), ease of deploying and maintenance of cables, and/or the like. As will be described in more detail later, the cabling system may comprise a plurality of components or devices for connecting various cables in an organized manner.

Herein, a cable is a substantially flexible, elongated apparatus for connecting devices. A cable may comprise two or more wires or fibre optic cores, wherein depending on the devices to be connected, the two or more wires may be electrically conductive wires, fiber optics, and/or the like.

A cable may be unterminated or terminated. An unterminated cable is generally a bare cable without any connectors. An unterminated cable may be connected to a device by securing stripped wires of the cable to a connection terminal of the device using suitable means such as crimp-on, soldering, binding, screw fastening, insulation-displacement connection (IDC), and/or the like.

A terminated cable usually comprise a substantially flexible, elongated body (often called a “sheath” or “jacket”) receiving therein the two or more wires, and at least one connector on at least one of the two longitudinally opposite ends thereof. In other words, a terminated cable may have two connectors on the two longitudinally opposite ends thereof, or may only have one connector on one longitudinal end thereof and the other end thereof has no connector.

A connector may be a male or female connector. Herein, the terms “port” and “jack” generally refer to a female connector which comprises a recess for receiving therein a male connector, and the terms “plug” and “crystal” generally refer to a male connector for inserting or extending into the recess of a female connector.

A connector comprises two or more terminals each in signal and/or power connection with one of the two or more wires or fibre optic cores for signal and/or power transmission. For example, the terminal of an electrical cable usually comprises two or more electrically conductive pins each conductively connected to one of the two or more wires. A terminal (such as a pin) may be a separate component connected to the corresponding wire or fibre optic core, or may be formed by an end portion thereof. For example, a registered-jack-45 (RJ45) jack has eight (8) pins formed by the end portions of eight (8) copper wires connected to the back of the RJ45 jack using the IDC method. A RJ45 plug also has eight (8) pins formed by the end portions of eight (8) copper wires crimped to the RJ 45 plug using a compression tool. When a plug is inserted into a jack, the terminals thereof are connected to establish signal and/or power connection.

In prior art, a cabling system may provide interconnectivity via point-to-point device connections. FIG. 4 is a schematic diagram showing a cabling system 270 deployed on a floor of the building 104 for connecting devices 102 to an equipment 272 such as a network switch using point-to-point device connection. A building of multiple floors may have a cabling system 270 deployed on each floor. The cabling systems 270 on different floors may be connected using copper or fibre backbone cabling.

As shown, the cabling system 270 comprises a plurality of telecommunication outlets 274 (which are generally ports), a patch panel 276, and a plurality of connectivity cables (described in more detail later).

The equipment 272 may be deployed on a rack in a telecommunication room (not shown). The patch panel 276 may be deployed in the telecommunication room or a telecommunication closet. The telecommunication outlets 274 may be deployed in various work areas of the floor.

In this example, the equipment 272 comprises a plurality of ports 288 for receiving cable plugs. The patch panel 276 comprises a set of ports 278 for receiving cable plugs, and a set of IDC points 280 for connecting bare wires, wherein the ports 278 and IDC points 280 are one-to-one connected, that is, a port 278 is connected to a respective IDC point 280, and an IDC point 280 is connected to a corresponding port 278.

Each telecommunication outlet 274 is connected to a respective port 278 (and thus the corresponding IDC point 280) of the patch panel 276 via a so-called horizontal cable 282, and the IDC point 280 is connected to a port 288 of the equipment 272 via an equipment cord or cable 290. Herein, a “horizontal cable” is a conventional term referring to a cable runs from a telecommunication outlet 274 to the telecommunications room, and does not necessarily mean that the cable has to run horizontally. The horizontal cable 282 may be up to 90 m (or 295 ft), and may be permanently deployed in the building 104 (for example, mounted or otherwise fixed to the building 104).

With the cabling system 270, a device 102 (such as a computer workstation) may be connected to a port 288 of the equipment 272 by connecting the device 102 to a telecommunication outlet 274 using a work-area cord or cable 292.

As can be seen, in the cabling system 270, each device 102 requires a separate set of cables 292, 282, and 290 for connection to the equipment 272. Therefore, the point-to-point device connection method (often labelled as a static and inflexible solution) is inefficient in deploying and reconfiguring the cabling system 270. Deployment and maintenance of the connectivity cables are labor-intensive and may cause a huge burden when deploying and maintaining the cabling system 270 with a large number of connectivity cables in a building 104 such as a business or enterprise building. Moreover, as the horizontal cables 282 are permanently deployed, changes of user locations or application may result in removal and disposal of the horizontal cables 282 and other components, and installation of new horizontal cables 282 and components, thereby causing waste of time, materials, and resources. Generally, the conventional point-to-point device connection method has various disadvantages such as:
limited to only an A to B connection;
lack of flexibility;
labor intensive;
disruptive;
wasteful; and
repeated costs.

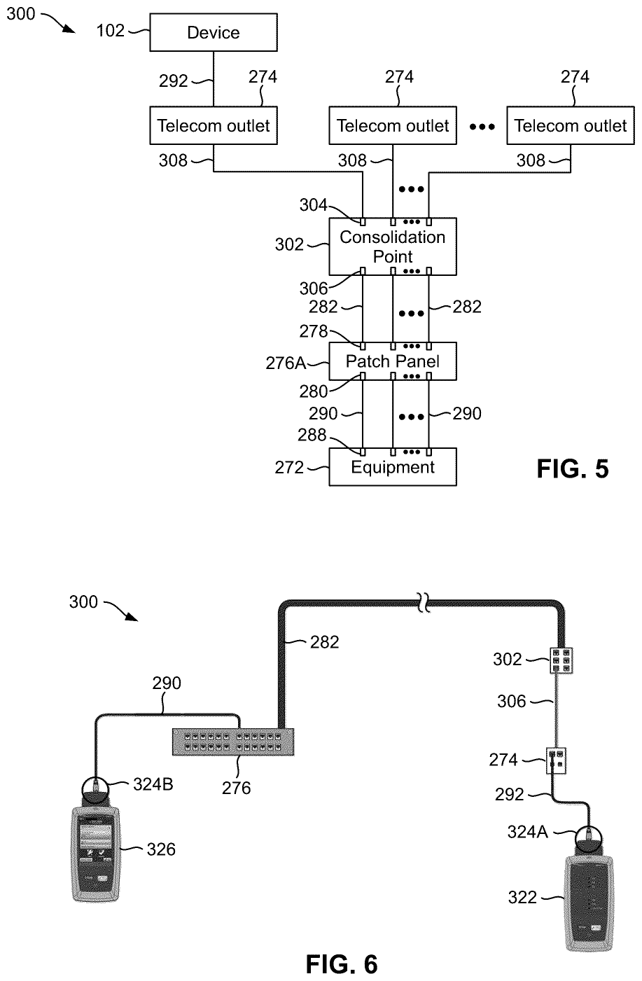

FIG. 5 is a schematic diagram showing a cabling system 300 deployed on a floor of the building 104 for connecting devices 102 to an equipment 272 such as a network switch, according to the ANSI/BICSI 007-2020 standard. A building of multiple floors may have a cabling system 300 deployed on each floor. The cabling systems 300 on different floors may be connected using copper or fibre backbone cabling.

The cabling system 300 uses a “zonal” cabling topology for achieving great flexibility, protecting the investment, and to build in a level of sustainability. As shown, the cabling system 300 comprises a plurality of telecommunication outlets 274, a consolidation point 302, a patch panel 276, and a plurality of connectivity cables (described in more detail later).

The equipment 272 may be deployed on a rack in a telecommunication room (not shown). The patch panel 276 may be deployed in the telecommunication room or a telecommunication closet. The telecommunication outlets 274 may be deployed in various work areas of the floor. The consolidation point 302 may be deployed near the work areas of the floor.

In this example, the equipment 272 comprises a plurality of ports 288. The patch panel 276 comprises a set of ports 278 and a set of IDC points 280, wherein the ports 278 and IDC points 280 are one-to-one connected. The consolidation point 302 comprises a set of ports 304 (for example, a set of RJ45 jacks), and a set of IDC points 306, wherein the ports 304 and IDC points 306 are one-to-one connected.

Each telecommunication outlet 274 is connected to a respective port 304 of the consolidation point 302 via a zone cord or cable 308. The zone cable 308 may be removably deployed in the building 104.

The IDC point 306 of the consolidation point 302 is connected to a port 278 (and thus the corresponding IDC point 280) of the patch panel 276 via a horizontal cable 282, and the IDC point 280 is connected to a port 288 of the equipment 272 via an equipment cord or cable 290. The horizontal cable 282 may be permanently deployed in the building 104.

With the cabling system 300, a device 102 (such as a computer workstation) may be connected to a port 288 of the equipment 272 by connecting the device 102 to a telecommunication outlet 274 using a work-area cord or cable 292.

In this example, the consolidation point 302 is used as a sub-patching facility for reconfiguration of the connectivity paths. As the permanently deployed horizontal cables 282 are between the consolidation point 302 and the patch panel 276A, changes in the work areas may not require removal and installation of horizontal cables 282, and may only need to reconfigure the removable zone cables 308 between the telecommunication outlets 274 and the consolidation point 302.

The cabling system 270 or 300 may need to meet or exceed the performance requirements of the designated classification defined in the commercial building telecommunication standards. As those skilled in the art understand, copper cabling transmission performance depends on cable characteristics, connecting hardware, patch cords and cross-connect wiring, the total number of connections, and the care with which they are installed and maintained. Therefore, to qualify system certification, performance testing must be done using approved field test instruments.

FIG. 6 is a schematic diagram showing a testing configuration of the cabling system 300, wherein a signal generator 322 is connected to a work-area cable 292 via a channel adapter 324A, and an analyzer 326 is connected to the corresponding equipment cable 290 via a channel adapter 324B. The signal generator 322 generates suitable test signals, and the analyzer 326 measures the test signals (the channel adapters 324A and 324B are usually excluded from the measuring) and analyzes the measured test signals to determine the performance of the channel between the signal generator 322 and the analyzer 326 (formed by the work-area cable 292, the telecommunication outlet 274, the zone cable 306, the consolidation point 302, the horizontal cable 282, the patch panel 276, and the equipment cable 290. After testing, the cabling system 300 may be certified in accordance with ANSI/TIA-568-C.2 or ISO 11801 Amendment 1 Class EA Ch AMD1.

While the use of the consolidation point 302 may provide flexibility for reconfiguration of the connectivity paths, the cabling system 300 still has some disadvantages such as:
increased capital expenditure (CAPEX; also called “capital expense”) due to increased materials and labor costs;
increased complexity in design; and
prolonged deployment time.

Therefore, there is a desire for an improved cabling system with optimized performances, such as an open “digital” architecture of structured cabling.

In the following, various embodiments of an improved cabling system are disclosed. In some of these embodiments, IP-network based interconnectivity is provided for sharing data on occupancy, space usage, temperature, and/or the like. Compared to conventional interconnectivity methods, the cabling system disclosed herein may be a faster and cheaper solution to make buildings 104 more responsive and more efficient, and lead to higher employee satisfaction and productivity.

The cabling system disclosed herein may be in compliance with various standards such as those listed in Table 1.

TABLE 1
Smart-building standards

| Standard | Notes |
|---|---|
| ANSI/TIA-862-B-2016 | Standard for structured cabling infrastructure |
| | for intelligent building systems |
| BICSI 007-2017 | Information and communications |
| | technology (ICT) design and |
| | implementation practices for |
| | digital buildings and premises |
| EN 50173-6: 2018 | Information technology - |
| | generic cabling systems - part 6: |
| | distributed building services |
| ISO/IEC 11801-6 | Information technology - |
| | generic cabling systems - part 6: |
| | distributed building services |

The cabling system disclosed herein may also comply with the environmental social and governance (ESG) requirements which are a subset of non-financial performance indicators including ethical, sustainable, and corporate governance issues such as making sure there are systems in place to ensure accountability and managing the building's carbon footprint.

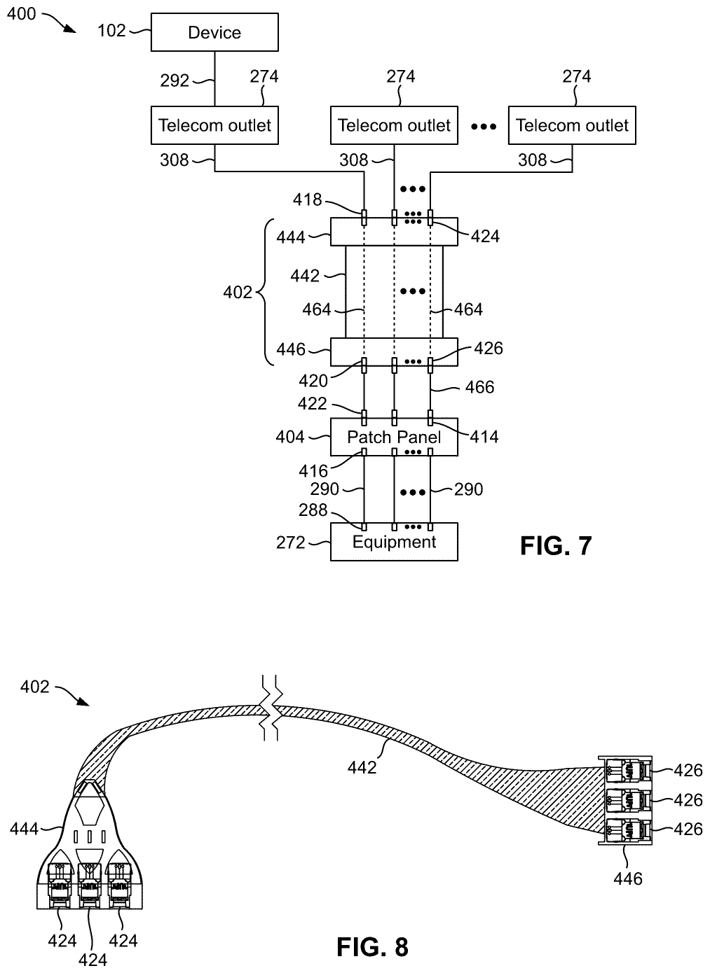

FIG. 7 is a schematic diagram showing a cabling system 400 for the BMS 100, according to some embodiments of this disclosure. The cabling system 400 may be deployed in the building 104 for connecting devices 102 to an equipment 272 such as a network switch.

A building of multiple floors may have a cabling system 400 deployed on each floor. The cabling systems 400 on different floors may be connected using copper or fibre backbone cabling.

As shown, the cabling system 400 comprises a plurality of telecommunication outlets 274, one or more loom cable assemblies 402, a patch panel 404, and a plurality of connectivity cables (described in more detail later).

The equipment 272 may be deployed on a rack in a telecommunication room (not shown). The patch panel 404 may be deployed in the telecommunication room and/or a telecommunication closet. The telecommunication outlets 274 may be deployed in various work areas of the floor. Each loom cable assembly 402 may be permanently deployed and extend from a work area to a location near the patch panel 404.

In this example, the equipment 272 comprises a plurality of ports 288 for receiving cable plugs. The patch panel 404 comprises a set of ports 414 for receiving cable plugs, and a set of IDC points 416 for connecting bare wires, wherein the ports 414 and IDC points 416 are one-to-one connected, that is, a port 414 is connected to a respective IDC point 416, and an IDC point 416 is connected to a corresponding port 414.

The loom cable assembly 402 comprises a set of first ports 424 each for connecting to a telecommunication outlet 274, and a set of second ports 426 each for connecting to a port 414 of the patch panel 404, wherein the first and second ports 424 and 426 are one-to-one connected, that is, a first port 424 is connected to a respective second port 426, and a second port 426 is connected to a corresponding first port 424. Thus, the loom cable assembly 402 combines the functions of the consolidation point 302 and the horizontal cable 282 to extend the cable connection from the patch panel 404 to a location in or near a work area. In some embodiments, the one or more loom cable assemblies 402 may be permanently deployed in the building 104.

In the work area, each telecommunication outlet 274 is connected to a respective first port 424 (and thus the corresponding second port 426) of the loom cable assembly 402 via a zone cord or cable 308 (which comprises a male plug 418 for inserting into the first port 424 of the loom cable assembly 402). The zone cable 308 may be removably deployed in the building 104.

As described above, the loom cable assembly 402 extends from the work area to a location near the patch panel 404 wherein the second port 426 of the loom cable assembly 402 is connected to a port 414 (and thus the corresponding IDC point 416) of the patch panel 404 using a patch cable 466 (which comprises a male plug 420 at one end thereof for inserting into the second port 426 of the loom cable assembly 402, and another male plug 422 at a longitudinally opposite end thereof for inserting into the port 414 of the patch panel 404). The IDC point 416 of the patch panel 404 is connected to a port 288 of the equipment 272 via an equipment cord or cable 290.

With the cabling system 400, a device 102 (such as a computer workstation) may be connected to the equipment 272 by connecting the device 102 to a telecommunication outlet 274 using a work-area cord or cable 292.

In these embodiments, the loom cable assembly 402 provides flexibility for reconfiguration of the connectivity paths, and avoids the deployment of consolidation points 302 and a large number of horizontal cables 282. Changes in the work areas may not require removal and installation of loom cable assemblies 402, and may only need to reconfigure the removable zone cables 308 between the telecommunication outlets 274 and the loom cable assembly 402. The removal of the connections between the consolidation point 302 and the horizontal cables 282 also reduces the risk of malfunction that may be otherwise caused by loose connections between the consolidation point 302 and the horizontal cables 282.

The cabling system 400 meets or exceeds the performance requirements of the designated classification defined in the commercial building telecommunication standards such as ANSI/TIA-862-B-2016, BICSI 007-2017, EN 50173-6:2018, and/or ISO/IEC 11801-6.

In some embodiments, the loom cable assembly 402 may be a pre-terminated cable, that is, having connectors on its longitudinally opposite ends, with a length between 25 ft and 300 ft. FIG. 8 is a schematic diagram showing the structure of an exemplary loom cable assembly 402, according to some embodiments of this disclosure. Also referring to FIG. 7, the loom cable assembly 402 comprises a flexible, elongated body 442 with a pair of connection assemblies, including a head assembly 444 and a hub assembly 446, on longitudinally opposite ends of the body 442.

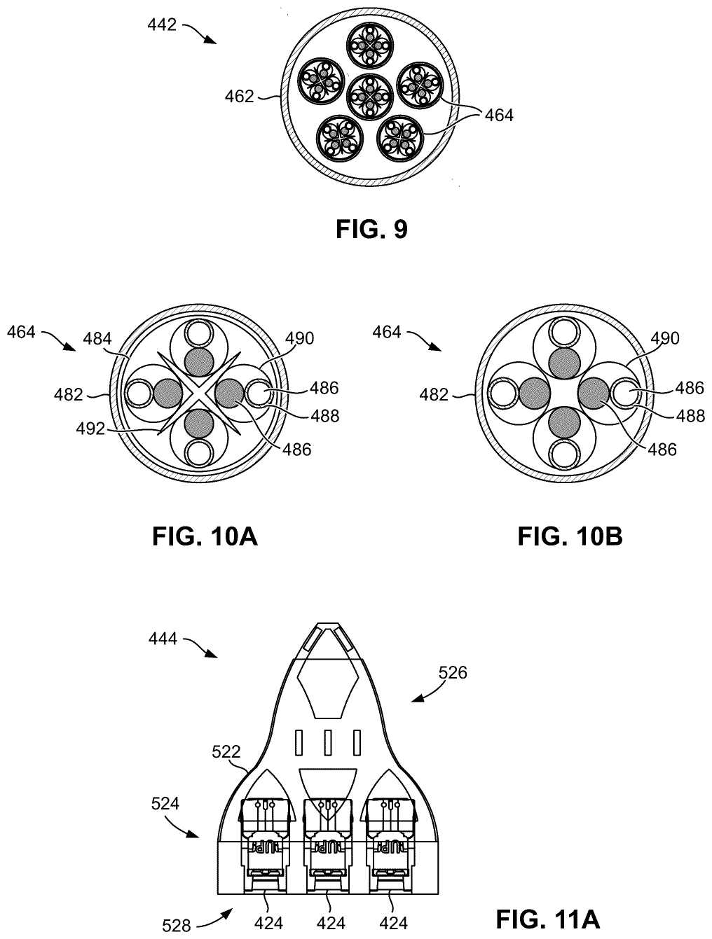

As shown in FIG. 9, the body 442 comprises a flexible, elongated sheath 462 such as an elongated tube made of a suitable flexible material. The sheath 462 receives therein a plurality of cables 464 (which are cables for transmitting signal and/or power) extending in the sheath 462 substantially in parallel along the lengthwise direction. In the example shown in FIG. 9, the body 442 comprises six (6) cables 464.

As shown in FIG. 10, each cable 464 may be a flame tests (FT) 6 cable and comprise a flexible, elongated jacket 482 such as an elongated tube made of a suitable flexible material with a noise-reduction shield 484 received therein. Inside the noise-reduction shield 484, the flexible, elongated jacket 482 receives therein a plurality of wires (such as electrically conductive wires and/or fiber optic cores). In the example shown in FIG. 10A (which may be a CAT 6A cable 464), the flexible, elongated jacket 482 receives therein eight (8) 23 American wire gauge (AWG) copper wires 486 arranged in four (4) wire pairs. In each wire pair, one copper wire is coated with a suitable insulation material 488, and the wire pair may be enclosed in an armoring 490 or may be a twisted pair. The wire pairs may be separated by a star filler 492.

In this example, the CAT 6A cable 464 may be a plenum-rated cable or a riser-rated cable with a limited power (LP) grading (defined by Underwriters Laboratories (UL)) of CMP-LP (0.6) Amps/Conductor. The star filler 492 may be fluoropolymer for plenum-rated cable 464 or high density polyethylene for riser-rated cable 464. The jacket 482 may be low-smoke, flame-retardant thermoplastic for plenum-rated cable 464 or flame-retardant thermoplastic for riser-rated cable 464. The jackets 482 of different wire pairs may be in different colors such as black, blue, white, and/or the like.

The CAT 6A cable 464 may be suitable for various applications such as HDBase-T A & B 10 gigabit (G) Ethernet (IEEE 802.3an), 5 gigabit Ethernet (IEEE 802.3bz), 2.5 gigabit Ethernet (IEEE 802.3bz), gigabit Ethernet (IEEE 802.3ab), 100 megabits per second (Mbps) Ethernet (IEEE 802.3u), 1000 Mbps asynchronous transfer mode (ATM), 622 Mbps ATM, 15 watts (W) power over Ethernet (PoE) (IEEE 802.3af), 30 W PoE+ (IEEE 802.3at), 60 W PoE++ (IEEE 802.3bt Type 3), 100 W PoE++ (IEEE 802.3bt Type 4), and/or the like.

The CAT 6A cable 464 may be suitable for operation between −20° C. and +75° C. (or −4° F. and +167° F.) with an input impedance of 100 ohm (Ω)+15Ω (for 1.0 megahertz (MHz) to 100 MHz), 100 Ω+20Ω (for 101 MHz to 250 MHz), or 100 Ω+25Ω (for 251 MHz to 500 MHz), a maximum capacitance unbalance of 330 picofarads (pF) per 100 meters (m), a voltage rating of 300 volts (V), a maximum delay skew of 45 nanoseconds (ns) per 30 m, and a nominal velocity of propagation (NVP) of 70% for plenum-rated cable 464 or 68% for riser-rated cable 464.

In some embodiments, the cable 464 may be a CAT 6 cable with a structure as shown in FIG. 10B. As can be see, the structure of the CAT 6 cable 464 is similar to that shown in FIG. 10A except that the CAT 6 cable 464 may not comprise a noise-reduction shield 484 nor a star filler 492.

In this example, the CAT 6 cable 464 may be a plenum-rated cable, a riser-rated cable, a riser-low smoke halogen free (LSHF) cable. The insulation coating 488 may be plenum-rated fluoropolymer for plenum-rated cable 464, polyolefin for riser-rated cable 464, or polyethylene for LSHF cable 464. The jacket 482 may be flame-retardant thermoplastic for plenum-rated cable 464 and riser-rated cable 464, or zero-halogen flame-retardant thermoplastic for LSHF cable 464. The jackets 482 of different wire pairs may be in different colors such as black, blue, white, and/or the like.

The CAT 6 cable 464 may be suitable for various applications such as 5 gigabit Ethernet (IEEE 802.3bz), 2.5 gigabit Ethernet (IEEE 802.3bz), gigabit Ethernet (IEEE 802.3ab), 100 Mbps Ethernet (IEEE 802.3u), 1000 Mbps ATM, 622 Mbps ATM, 15 W PoE (IEEE 802.3af), 30 W PoE+ (IEEE 802.3at), 60 W PoE++ (IEEE 802.3bt Type 3), 100 W PoE++ (IEEE 802.3bt Type 4), and/or the like.

The CAT 6 cable 464 may be suitable for operation between −20° C. and +75° C. (or −4° F. and +167° F.) with an input impedance of 100 Ω+15Ω (for 1.0 megahertz (MHz) to 100 MHz) or 100 Ω+20Ω (for 101 MHz to 250 MHz), a maximum capacitance unbalance of 330 pF per 100 m, a maximum delay skew of 45 ns per 30 m, and a NVP of 70% for plenum-rated cable 464 or 68% for riser-rated cable 464.

In some embodiments, the cables 464 may be any suitable cables such as CAT 5, CAT 5e, CAT 6, CAT 6A, CAT 6e, CAT 7, and/or CAT 8 cables.

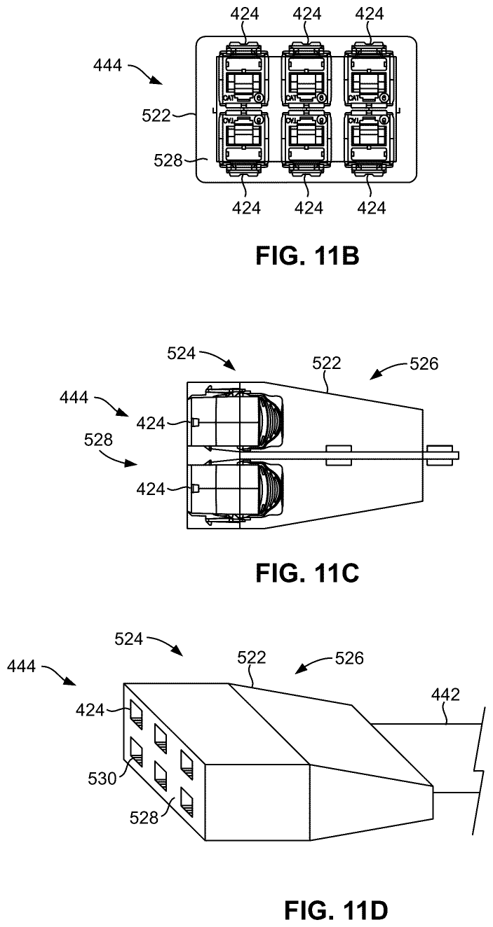

FIGS. 11A to 11D show the head assembly 444 of the loom cable assembly 402 for providing the function of a consolidation point, according to some embodiments of this disclosure. As shown, the head assembly 444 comprises a housing 522 having a front portion 524 and a rear portion 526 substantially rearward-tapering from the front portion 524 for ease of gripping. In some embodiments, the front portion 524 is made of a rigid or semi-rigid material to allow a user to easily insert the plug of a cable into a port 424 of head assembly 444 (described in more detail below).

The front portion 524 comprises a plurality of ports 424 therein mounted or otherwise secured at fixed locations on the distal sidewall 528 of the housing 522 (that is, the structures of the ports 424 are received in the housing 522 (or more specifically, the first portion 524 thereof) on or adjacent a distal end of the housing 522 with the recesses of the ports 424 opening on the distal sidewall 528 of the housing 522). Alternatively, some or all of the plurality of ports 424 may be integrated into the front portion 524 of the housing 522 with the recesses of the ports opening on the distal sidewall 528 thereof. Each port 424 comprises, in the recess thereof, necessary pins 528 connected to the wires 486 of a respective cable 464 (which extends out of the housing 522 from a proximal side of the rear portion 526).

For example, the housing 522 may be a three-dimensional (3D) printed housing receiving therein six (6) registered-jack-45 (RJ45) ports 424 arranged at fixed locations as a three-by-two matrix on the distal sidewall 528 of the housing 522. In some embodiments, the RJ45 ports 424 may be CAT 6 or 6A jacks.

Those skilled in the art will appreciate that, in some embodiments, the rear portion 526 may have other suitable shapes. Moreover, the partitioning of the housing 522 into a front portion 524 and a rear portion 526 is for ease of description only, and those skilled in the art will understand that the housing 522 does not have to be partitioned into two portions.

Those skilled in the art will appreciate that, in some embodiments, the ports 424 may be positioned at fixed locations on one or more sidewalls (such as the distal sidewall, top wall, bottom wall, lateral sidewall, and/or the like) of the housing 522.

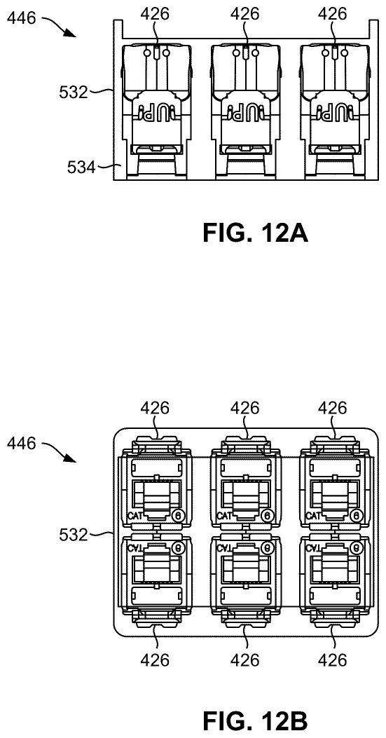

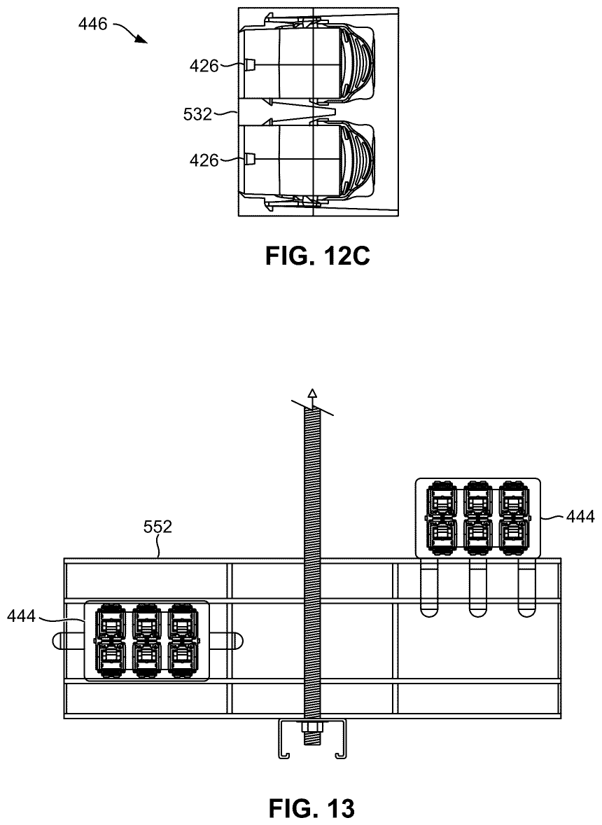

FIGS. 12A to 12C show the hub assembly 446 of the loom cable assembly 402 for acting as a hub, according to some embodiments of this disclosure. As shown, the hub assembly 446 comprises a housing 532 having a plurality of ports 426 therein mounted, secured, or integrated to the housing 532 at fixed locations on the distal sidewall thereof. Each port 424 comprises, in the recess thereof, necessary pins connected to the wires 486 of a respective cable 464. For example, the housing 532 may be a 3D-printed housing receiving therein six (6) RJ45 ports 426 arranged as a three-by-two matrix. In some embodiments, the RJ45 ports 426 may be CAT 6 or 6A jacks.

In some embodiments, the housing 532 may be made of a rigid or semi-rigid material.

In some embodiments, the ports 426 may be positioned at fixed locations on one or more sidewalls (such as the distal sidewall, top wall, bottom wall, lateral sidewall, and/or the like) of the housing 532.

Thus, the ports 424 and 426 of the head assembly 444 and the hub assembly 446 are paired with each pair of ports 424 and 426 connected by a cable 464. In some embodiments, the port pairs are indicated by suitable means. For example, in some embodiments, the ports 424 of the head assembly 444 are arranged in a predefined order known to the users, and the ports 426 of the hub assembly 446 are arranged in a predefined corresponding order (for example, the same, predefined order) also known to the users. In some embodiments, the ports 424 and 426 of the head assembly 444 and hub assembly 446 are marked in different colors such that each pair of ports 424 and 426 have the same color. In some embodiments, the ports 424 and 426 of the head assembly 444 and hub assembly 446 are marked with different numbers such that each pair of ports 424 and 426 have the same number.

As shown in FIG. 13, in some embodiments, the head assembly 444 of the loom cable assembly 402 may be mounted to a standard plenum or under-floor cable tray 552.

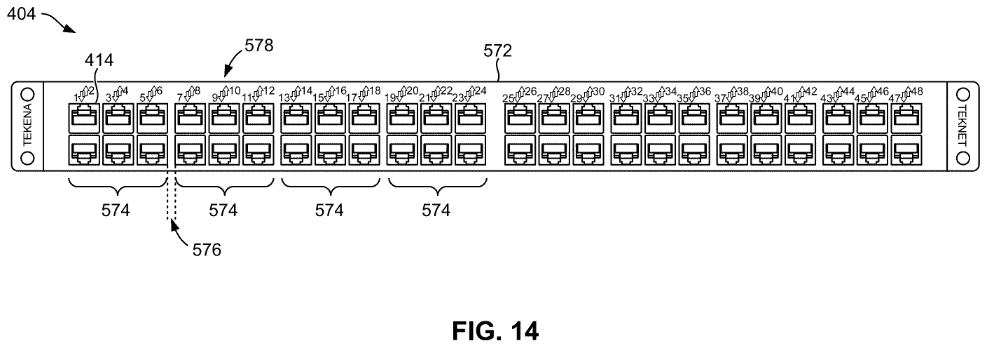

FIG. 14 is a schematic cross-sectional view of the patch panel 404, according to some embodiments of this disclosure.

As shown, the patch panel 404 comprises a body 572 having a plurality of ports 414 on a front side thereof and a plurality of IDC points 416 on a rear side thereof (not shown). The ports 414 are arranged in one or more groups 574. In each group 574, the ports 414 are arranged at corresponding locations for receiving and connecting the hub assembly 446 of a loom cable assembly 402. Adjacent port groups 574 are spaced from each other with a distance 576 sufficient for adapting to the total thickness of the sidewalls of the corresponding hub assemblies 446. The ports 414 may be marked with indicators 578 (such as on the front wall of the patch panel 404) for differentiating the ports 414.

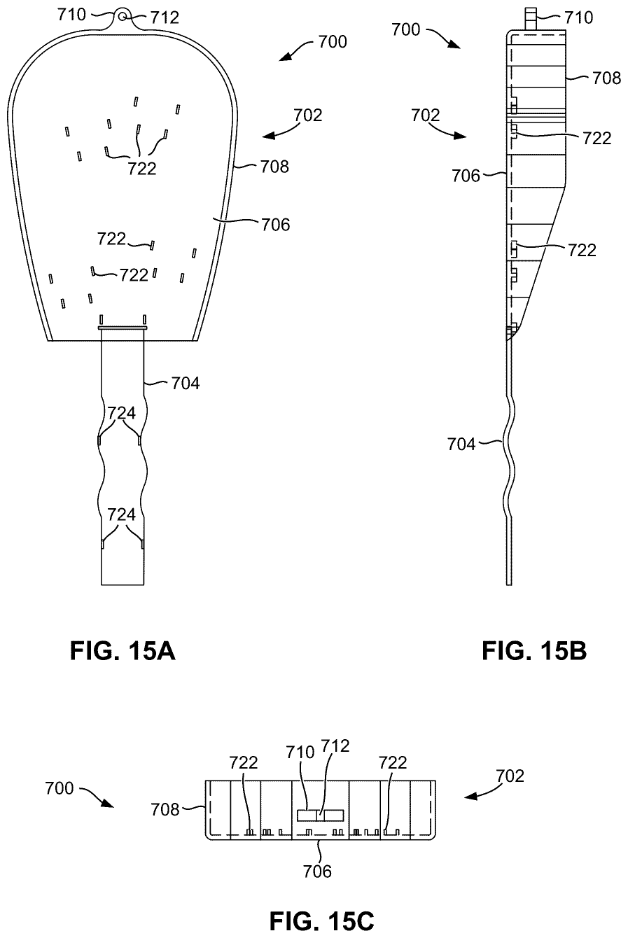

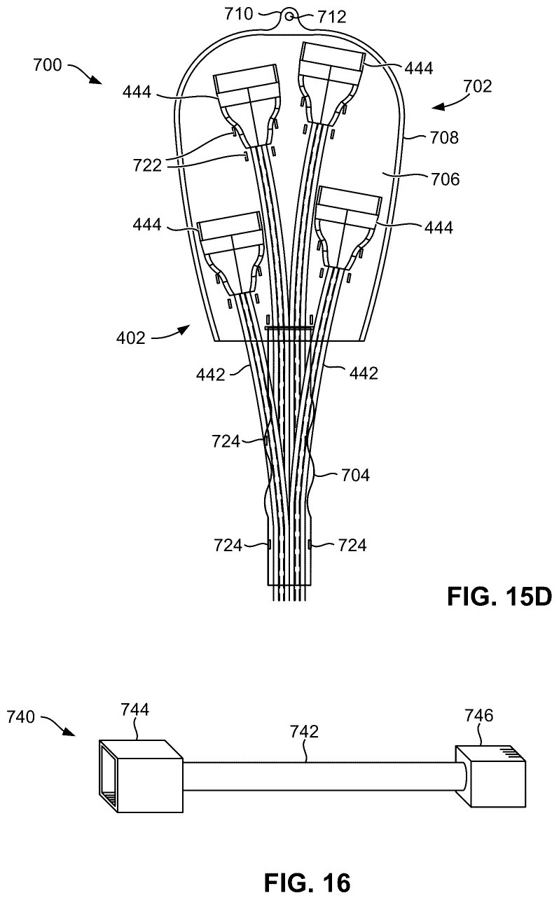

FIGS. 15A and 15D show a cable-pulling sled 700 for pulling a plurality of loom cable assemblies 402 to extend them from a patch panel to a work area. As shown, the cable-pulling sled 700 comprises a head housing 702 and a cable-retention strap 704 extending rearwardly from the head housing 702.

The head housing 702 may be made by 3D printing or injection molding, and comprises a base 706 with a plurality of tie-downs 722 extending upwardly from various locations of the base 702, and a wall 708 extending upwardly along the peripheral of the base 706. A pulling handle 710 extends forwardly from a front portion of the wall 708, and comprises a hole 712 so that a user may tie a string thereto for pulling the loom cable assemblies 402 when needed.

The cable-retention strap 704 may be made of a strong and abrasion resistant polyester webbing, and comprises strings 724 therealong for securing the bodies 442 of loom cable assemblies 402 to the cable-retention strap 704.

FIG. 15D shows cable-pulling sled 700 with four loom cable assemblies 402 secured thereto. The tie-downs 722 of cable-pulling sled 700 are grouped with each group of tie-downs 722 for retaining the head assemblies 444 and neighboring portions of the bodies 442 of a loom cable assembly 402 to the base 706. Moreover, the tie-downs 722 are arranged at locations such that the head assemblies 444 of loom cable assemblies 402 are arranged in a zig-zag manner (that is, neighboring head assemblies 444 are retained at misaligned positions along the lengthwise direction) for avoiding using a wide base 706 that may be otherwise required to pull the same number of loom cable assemblies 402.

In some embodiments, the cable-pulling sled 700 may be used for retaining and pulling the hub assemblies 446 of a plurality of loom cable assemblies 402.

FIG. 16 is a schematic perspective view of a component cable assembly 740 for use with the loom cable assembly 402 shown in FIG. 8, according to some embodiments of this disclosure. The component cable assembly 740 comprises a flexible, elongated body 742, a female connector 744 such as a female RJ45 connector on one end of the flexible body 742, and a male connector 746 such as a male RJ45 connector on the other end of the flexible body 742. In these embodiments, although the length of the flexible body 742 may be different to the flexible body 442, the flexible body 742 has the same electrical specifications (such as the wires in the flexible body 742, the manner of twisting thereof, the noise-reduction shield, and the like, except length-related specifications) as the flexible body 442 of the loom cable assembly 402 for electrically matching the flexible body 442 of the loom cable assembly 402 (electrical matching is important for the cable-system performance and to meet relevant standards). In some embodiments, the mechanical specifications of the flexible body 742 (such as the material of the sheath, jacket, and the like) may also be the same as the flexible body 442 for simplifying logistic needs and related cost reduction).

For example, the flexible body 742 may be the same as the flexible body 442 as shown in FIGS. 9 to 10B. More specifically, referring to FIG. 9, the flexible body 742 (being the same as the flexible body 442) comprises a flexible, elongated sheath 462 such as an elongated tube made of a suitable flexible material. The sheath 462 receives therein a plurality of cables 464 (which are cables for transmitting signal and/or power) extending in the sheath 462 substantially in parallel along the lengthwise direction. In the example shown in FIG. 9, the body 442 comprises six (6) cables 464.

As shown in FIG. 10, each cable 464 may be a flame tests (FT) 6 cable and comprise a flexible, elongated jacket 482 such as an elongated tube made of a suitable flexible material with a noise-reduction shield 484 received therein. Inside the noise-reduction shield 484, the flexible, elongated jacket 482 receives therein a plurality of wires (such as electrically conductive wires and/or fiber optic cores). In the example shown in FIG. 10A (which may be a CAT 6A cable 464), the flexible, elongated jacket 482 receives therein eight (8) 23 American wire gauge (AWG) copper wires 486 arranged in four (4) wire pairs. In each wire pair, one copper wire is coated with a suitable insulation material 488, and the wire pair may be enclosed in an armoring 490 or may be a twisted pair. The wire pairs may be separated by a star filler 492.

In this example, the CAT 6A cable 464 may be a plenum-rated cable or a riser-rated cable with a limited power (LP) grading (defined by Underwriters Laboratories (UL)) of CMP-LP (0.6) Amps/Conductor. The star filler 492 may be fluoropolymer for plenum-rated cable 464 or high density polyethylene for riser-rated cable 464. The jacket 482 may be low-smoke, flame-retardant thermoplastic for plenum-rated cable 464 or flame-retardant thermoplastic for riser-rated cable 464. The jackets 482 of different wire pairs may be in different colors such as black, blue, white, and/or the like.

In above embodiments, each of the head assembly 444 and the hub assembly 446 of the loom cable assembly 402 comprises a plurality of ports. In some embodiments, any one or each of the head assembly 444 and the hub assembly 446 of the loom cable assembly 402 may comprise a plurality of plugs mounted or otherwise secured at fixed locations on or adjacent a distal end of the housing 522 or 532. In these embodiments, the cables used for connecting to the plugs of the loom cable assembly 402 need to have corresponding ports.

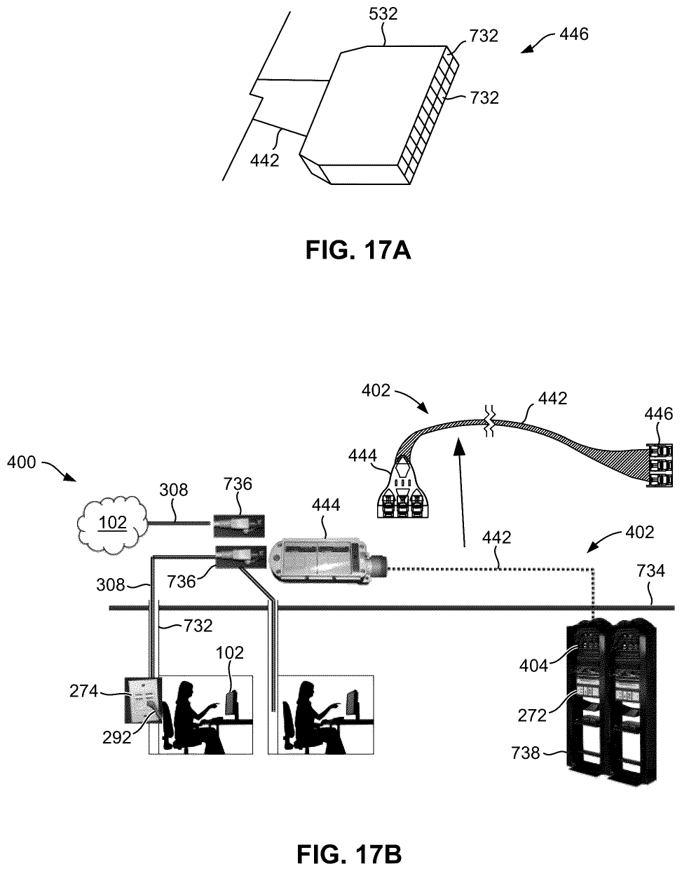

In some embodiments, any one or each of the head assembly 444 and the hub assembly 446 of the loom cable assembly 402 may comprise an IDC connector connected to the cables 464 in the body 442 thereof. For example, as shown in FIG. 17A, the hub assembly 446 of the loom cable assembly 402 may be in the form of an IDC connector, and comprise a housing 532 having a plurality of pin holes 732 at a distal end thereof. Each pin hole 732 comprises an electrically conductive pin sleeve received therein and connected to a wire of the cables 464 in the body 442 thereof.

As shown in FIG. 17B, a user's computing device 102 in a work area may be connected to a telecommunication outlet 274 via a work-area cable 292. A zone cable 308 connects the telecommunication outlet 274 and extends through a conduit 732 or “free air” to above ceiling 734 and connects to the head assembly 444 of a loom cable assembly 402 by inserting the plug 736 of the zone cable 308 into a port of the head assembly 444 of the loom cable assembly 402. The loom cable assembly 402 extends above the ceiling 734 from the work area to a rack 738 in a telecommunication room which accommodates a patch panel 404 and an equipment 272.

In some embodiments, the loom cable assembly 402 comprises a hub assembly 446 in the form of an IDC connector as shown in FIG. 17A, which is “clicked” to, mated to, or otherwise coupled to the IDC points on the rear side of the patch panel 404. An equipment cable 290 (not shown) is used to connect the ports 414 of the patch panel 404 to the ports 288 of the equipment 272.

In some embodiments, the loom cable assembly 402 may only comprise the head assembly 444 on one longitudinal end thereof, with the opposite end thereof being unterminated (that is, no hub assembly 446).

In some embodiments, the loom cable assembly 402 may only comprise the hub assembly 446 on one longitudinal end thereof, with the opposite end thereof being unterminated (that is, no head assembly 444).

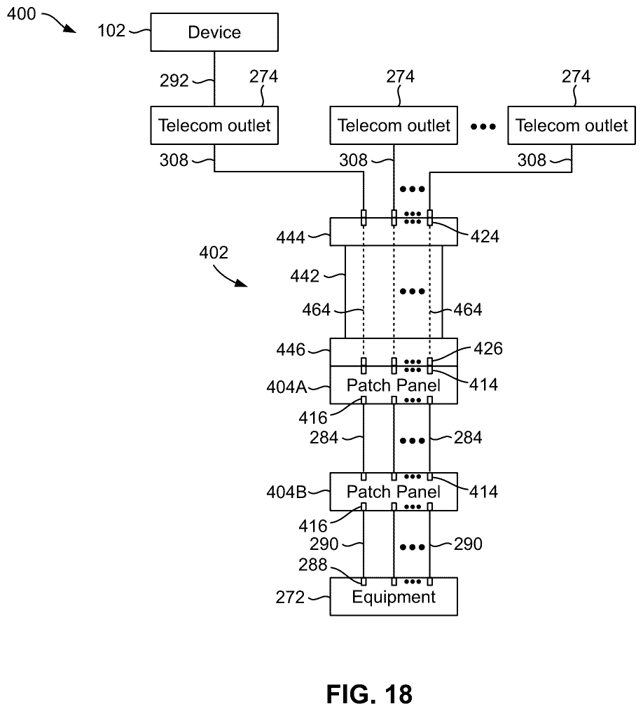

FIG. 18 is a schematic diagram showing a cabling system 400 according to some embodiments of this disclosure. The cabling system 400 is similar to that shown in FIG. 7 except that the cabling system 400 in these embodiments may comprise a plurality of patch panels 404A and 404B in series connection via one or more cross-connect cables 284.

The cabling system 400 may provide high-performance infrastructures of various IT and OT technologies, in compliance with various relevant standards. Table 2 lists some IT and OT building system applications and the standards relevant thereto. The cabling system 400 is suitable for delivering the data rates and power (for example, via PoE) required to support the applications for smart buildings.

TABLE 2
IT/OT building system applications and relevant standards

| | Standards | | |
|---|---|---|---|
| Application | TIA | ISO/IEC | ANSI |
| Intelligent | TIA 862-B | ISO 11801-6 | ANSI/BICSI-007 |
| Buildings | | | |
| WI-FI ® | TIA | ISO TR 24704 | |
| | TSB-162 | | |
| 2.5 G/5 G Base-T | TIA | ISO 11801-9904 | |
| | TSB-5021 | | |
| POE | TIA | ISO 14763-2 | |
| | TSB-184-A | | |
| Healthcare | TIA 1179 | | |
| Data Centers | TIA 942-A | ISO 11801-5 | |
| Education | TIA 4966 | | |

More specifically, the cabling system 400 is in compliance with various PoE standards (see Table 3) for combining data communications and power delivery over each sub-cable 464.

TABLE 3
PoE standards

| | | Max. power | Usable power budget | | |
|---|---|---|---|---|---|
| | | output for power | for the end device (that | | |
| | Number of | sourcing | is, powered device | | |
| | pairs needed | equipment (PSE) | (PD)) | | Standard |
| PoE | 2 | Class 1: 15.4 W | 12.95 | W | IEEE 802.3af, Type 1 |
| PoE+ | 2 | Class 4: 30 W | 25.50 | W | IEEE 802.3at, Type 2 |
| PoE++ | 4 | Class 6: 60 W | 49 | W | IEEE 802.3bt, Type 3 |
| PoE++ | 4 | Class 8: 90 W | 96 | W | IEEE 802.3bt, Type 4 |

The loom cable assembly 402 provides a simple, efficient, and robust pre-terminated cabling assembly for the cabling system 400. With the loom cable assembly 402, the cabling system 400 may make the zonal cabling solution simpler, better, and more cost effective.

Compared to traditional cabling methods and the premium cost and overhead zonal methods, the cabling system 400 provides improved functionality and simplified cable deployment.

For example, the cabling system 400 may provide at least the following benefits:
Pre-terminated: The pre-terminated loom cable assemblies 402 remove the labor from the field and produce a product off plan to factory quality. With the pre-terminated loom cable assemblies 402, many construction elements have moved to a prefabricated model thereby simplifying and unifying the smart cabling.
Pre-tested: The cabling system 400 may be factory assembled and 100% tested prior to shipping for providing enhanced assurance of quality. The test results may be sent to installation contractors for de-risking their work.

Simplified deployment: The cabling system 400 simplifies cable deployments with features such as the patch panel.

In a conventional patch panel, the ports (such as 24 or 48 ports) are generally arranged in a 1U space (wherein “U” is a reference to the rack space “unit” taken up and is a standard of 1¾ inches in height and 19 inches width). For example, the ports of a conventional 48-port patch panel are generally arranged in two rows and are numbered from left to right in the first row as 1 to 24 and from left to right in the second row as 25 to 48. Such a port arrangement is different to that of current network switches. In the embodiments shown in FIG. 14, the ports 414 of the patch panel 404 are arranged in one or more groups 574 (also denoted “clusters” or “blocks”) each having a predefined number of ports (such as six (6) ports in two-row and three-column arrangement), which is consistent to the port arrangement of the network switches. Such a port arrangement of the patch panel 404 allows the users to use a small loom cable with six (6) pre-terminated RJ45 plugs on each end thereof to quickly connect a group of ports 414 of the patch panel 404 to the corresponding group of ports of the network switch, thereby further improving cable management compared to the conventional patch panel that requires six (6) individual patching cables.
Labor saving: On-site man-power saving may be up to 75%.
Time saving: Cable deployment time may be reduced by 75%. The most time-consuming element of cabling is the termination process which typically costs two thirds of the cable-deployment time and requires the most skills. Thus, with the use of pre-terminated loom cable assemblies 402, all the termination work may be removed from the construction site, thereby requiring less technicians and reduced skills, addressing the issue of industry skills gap, and achieving fast cable deployment.
Lowered management overhead: A reduction of required onsite labor hours may de-conflict trade activities and project management time.
Logistics: The prefabricated cabling system 400 may allow just-in-time delivery of the product thereby removing storage and management overheads.
Ease of deployment: The design and assembly of the cabling system 400 may conducted offsite, thereby resulting in a simple-to-deploy solution that requires less qualified labors to install.
Waste reduction: With the cabling system 400, cables and components may be used as required in the factory to produce the precise cable assembly to fit the requirement, thereby eliminating source materials waste.
ESG Compliance: The cabling system 400 is ESG compliant with reduction of environmental impact.
Sustainability: The cabling system 400 is reconfigurable, removable, and relocatable. All component assemblies of the cabling system 400 may be “plug & play” allowing removal and reuse. In many embodiments, 100% of the overall system is reusable.

### B. Cabling Design System

There are industry standards of cabling systems for smart buildings made by relevant standards organizations with the goal of achieving efficiencies for all the building operations, control, safety, communications, information technology (IT and IoT), data management, and/or the like. However, the construction industry to date is offered only traditional methods of cabling-system design and deployment, giving rise to solutions that fall short of the stated objectives. Often, the building services are treated as stand-alone silos with no or very little interoperability. Each system's connectivity requirements are designed using outdated practices and often installed independently missing the benefits of efficiencies and savings.

A challenge identified is the lack of a design platform specifically developed to meet the demands of the smart IoT cabling concepts. Just as important for industry adoption, is the need for simplifying the deployment process. The development of a built for purpose tool ensures that the project goals are supported through an effective planning and deployment software platform.

In some embodiments, a cabling design system is provided for designing the cabling system disclosed herein. As will be described in more detail later, the cabling design system disclosed herein addresses at least some of the weakness in the conventional design and implementation tools to support smart buildings and IoT integration of services over a common cabling system.

In some embodiments, the cabling design system may be a software-as-a-service (SaaS) platform for smart cabling design, planning, and deployment, which is important to ensure the successful implementation of the smart cabling system. In some embodiments, the cabling design system in conjunction with above-described cabling system may be used to proactively identify, capture, and prescribe all steps of the smart building cable design process from needs assessment, to design, and to deployment, thereby replacing current manual methods with improved efficiencies.

The cabling design system disclosed herein uses an automated, intelligent step-by-step process to accurately ensure the realization of the full functionality (see FIG. 3) of smart cabling capabilities (including smart IoT cabling capabilities). The cabling design system disclosed herein utilize and conform to the latest smart-building standards (see Table 1). The capabilities of the cabling design system disclosed herein ensure full integration and interoperability of all smart-building services and functions guiding architects, engineers, constructors, and technicians during scoping, design, procurement, construction, and deployment to achieve the optimal system intent and capabilities, allowing customers to self-serve in designing, planning, and implementing the smart cabling system.

In various embodiments, the cabling design system disclosed herein provides:
modelling the methodology (described in more detail later) used by a smart-building cabling design expert to ensure consistent, optimized, best practice results;
guiding and prescribing through the smart building end-user needs assessment to ensure the cabling system support all current and future potential application requirements;
designing the comprehensively integrated smart cabling solution by translating the complete, integrated needs requirements into an optimized cabling design for specifying the components, materials, installation, commissioning, and operational procedures to support all of the smart capabilities desired;
overlaying onto architectural drawings and de-conflict other building services;
integrating to third-party software such as Autodesk suite including AutoCAD, Revit, and/or the like.
creating a design and associated product/component bill of materials;
creating construction deployment drawings, product list, length sheet, installation labelling plan, and/or the like;
utilizing machine-learning technologies to calculate optimal routes and cable lengths based on floor layout and density, streamlining the design process while maintaining network standards;
dynamically updating design methodologies, specifications, and other baseline data to ensure timeliness and accuracy.

The cabling design system disclosed herein thus provides an improvement to computer technologies and expands computer technologies to cabling design areas. The cabling design system disclosed herein also uses computer technologies to provide improvements in non-computer areas such as improvements in cabling design areas.

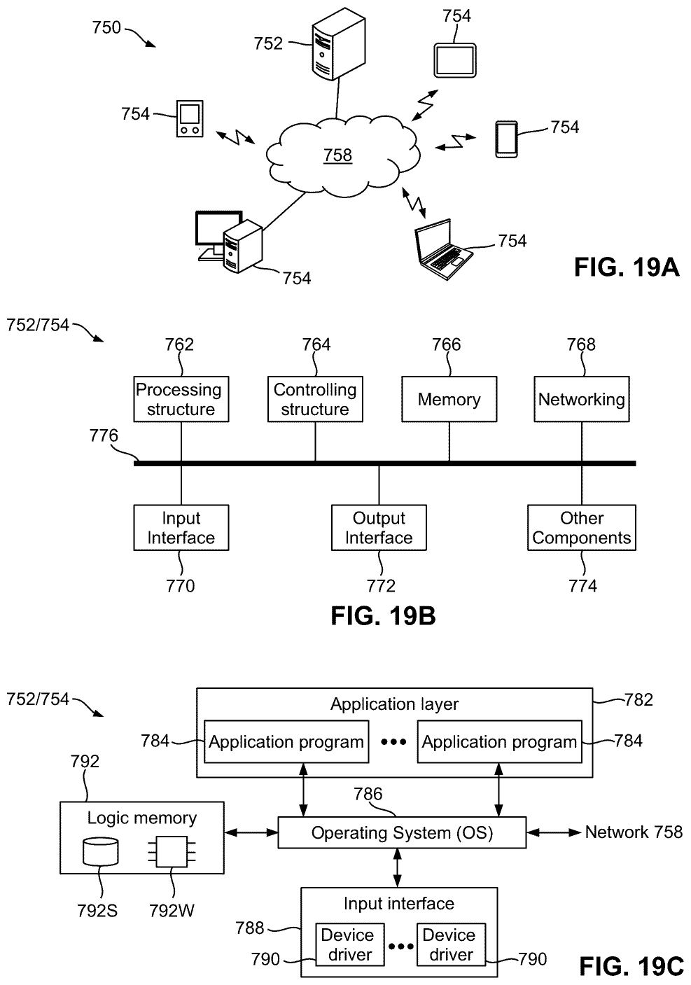

FIG. 19A is a schematic diagram showing a cabling design system 750 in the form of a computer network system. As shown, the cabling design system 750 comprises one or more server computers 752 and a plurality of client computing devices 754 functionally interconnected by a network 758, such as the Internet, a local area network (LAN), a wide area network (WAN), a metropolitan area network (MAN), and/or the like, via suitable wired and/or wireless networking connections.

The server computers 752 may be computing devices designed specifically for use as a server, and/or general-purpose computing devices acting as server computers while also being used by various users. Each server computer 752 may execute one or more server programs. In various embodiments, a server computer 752 may be on premise (that is, a local server computer) or a cloud-based server (which may be at a remote location).

The client computing devices 754 may be portable and/or non-portable computing devices such as laptop computers, tablets, smartphones, Personal Digital Assistants (PDAs), desktop computers, and/or the like. Each client computing device 754 may execute one or more client application programs which sometimes may be called “apps”.

Generally, the computing devices 752 and 754 have a similar hardware structure such as a hardware structure shown in FIG. 19B. As shown, the computing device 752/754 comprises a processing structure 762, a controlling structure 764, one or more non-transitory computer-readable memory or storage devices 766, a network interface 768, an input interface 770, and an output interface 772, functionally interconnected by a system bus 776. The computing device 752/754 may also comprise other components 774 coupled to the system bus 776.

The processing structure 762 may be one or more single-core or multiple-core computing processors such as INTEL® microprocessors (INTEL is a registered trademark of Intel Corp., Santa Clara, CA, USA), AMD® microprocessors (AMD is a registered trademark of Advanced Micro Devices Inc., Sunnyvale, CA, USA), ARM® microprocessors (ARM is a registered trademark of Arm Ltd., Cambridge, UK) manufactured by a variety of manufactures such as Qualcomm of San Diego, California, USA, under the ARM® architecture, or the like. When the processing structure 762 comprises a plurality of processors, the processors thereof may collaborate via a specialized circuit such as a specialized bus or via the system bus 776.

The processing structure 762 may also comprise one or more real-time processors, programmable logic controllers (PLCs), microcontroller units (MCUs), μ-controllers (UCs), specialized/customized processors and/or controllers using, for example, field-programmable gate array (FPGA) or application-specific integrated circuit (ASIC) technologies, and/or the like.

Generally, each processor of the processing structure 762 comprises necessary circuitries implemented using technologies such as electrical and/or optical hardware components for executing one or more processes as the implementation purpose and/or the use case maybe, to perform various tasks. In many embodiments, the one or more processes may be implemented as firmware and/or software stored in the memory 766. Those skilled in the art will appreciate that, in these embodiments, the one or more processors of the processing structure 762, are usually of no use without meaningful firmware and/or software.

Of course, those skilled the art will appreciate that a processor may be implemented using other technologies such as analog technologies.

The controlling structure 764 comprises one or more controlling circuits, such as graphic controllers, input/output chipsets, and the like, for coordinating operations of various hardware components and modules of the computing device 752/754.

The memory 766 comprises one or more one or more non-transitory computer-readable storage devices or media accessible by the processing structure 762 and the controlling structure 764 for reading and/or storing instructions for the processing structure 762 to execute, and for reading and/or storing data, including input data and data generated by the processing structure 762 and the controlling structure 764. The memory 766 may be volatile and/or non-volatile, non-removable or removable memory such as RAM, ROM, EEPROM, solid-state memory, hard disks, CD, DVD, flash memory, or the like. In use, the memory 766 is generally divided into a plurality of portions for different use purposes. For example, a portion of the memory 766 (denoted as storage memory herein) may be used for long-term data storing, for example, for storing files or databases. Another portion of the memory 766 may be used as the system memory for storing data during processing (denoted as working memory herein).

The network interface 768 comprises one or more network modules for connecting to other computing devices or networks through the network 758 by using suitable wired and/or wireless communication technologies such as Ethernet, WI-FI®, BLUETOOTH® (BLUETOOTH is a registered trademark of Bluetooth Sig Inc., Kirkland, WA, USA), Bluetooth Low Energy (BLE), Z-Wave, Long Range (LoRa), ZIGBEE® (ZIGBEE is a registered trademark of ZigBee Alliance Corp., San Ramon, CA, USA), wireless broadband communication technologies such as Global System for Mobile Communications (GSM), Code Division Multiple Access (CDMA), Universal Mobile Telecommunications System (UMTS), Worldwide Interoperability for Microwave Access (WiMAX), CDMA2000, Long Term Evolution (LTE), 3GPP, 5G New Radio (5G NR) and/or other 5G networks, and/or the like. In some embodiments, parallel ports, serial ports, USB connections, optical connections, or the like may also be used for connecting other computing devices or networks although they are usually considered as input/output interfaces for connecting input/output devices.

The input interface 770 comprises one or more input modules for one or more users to input data via, for example, touch-sensitive screens, touch-sensitive whiteboards, touch-pads, keyboards, computer nice, trackballs, microphones, scanners, cameras, and/or the like. The input interface 770 may be a physically integrated part of the computing device 752/754 (for example, the touch-pad of a laptop computer or the touch-sensitive screen of a tablet), or may be a device physically separated from but functionally coupled to, other components of the computing device 752/754 (for example, a computer mouse). The input interface 770, in some implementation, may be integrated with a display output to form a touch-sensitive screen or a touch-sensitive whiteboard.

The output interface 772 comprises one or more output modules for output data to a user. Examples of the output modules include displays (such as monitors, LCD displays, LED displays, projectors, and the like), speakers, printers, virtual reality (VR) headsets, augmented reality (AR) goggles, and/or the like. The output interface 772 may be a physically integrated part of the computing device 752/754 (for example, the display of a laptop computer or a tablet), or may be a device physically separate from but functionally coupled to other components of the computing device 752/754 (for example, the monitor of a desktop computer).

The computing device 752/754 may also comprise other components 774 such as one or more positioning modules, temperature sensors, barometers, inertial measurement units (IMUs), and/or the like. Examples of the positioning modules may be one or more global navigation satellite system (GNSS) components (for example, one or more components for operation with the Global Positioning System (GPS) of USA, Global'naya Navigatsionnaya Sputnikovaya Sistema (GLONASS) of Russia, the Galileo positioning system of the European Union, and/or the Beidou system of China).

The system bus 776 interconnects various components 762 to 774 enabling them to transmit and receive data and control signals to and from each other.

FIG. 19C shows a simplified software architecture of the computing device 752 or 754. The software architecture comprises an application layer 782, an operating system 786, a logical input/output (I/O) interface 788, and a logical memory 792. The application layer 782, operating system 786, and logical I/O interface 788 are generally implemented as computer-executable instructions or code in the form of software programs or firmware programs stored in the logical memory 792 which may be executed by the processing structure 762.

Herein, a software or firmware program is a set of computer-executable instructions or code stored in one or more non-transitory computer-readable storage devices or media such as the memory 766, and may be read and executed by the processing structure 762 and/or other suitable components of the computing device 752/754 for performing one or more processes. Those skilled in the art will appreciate that a program may be implemented as either software or firmware, depending on the design purposes and requirements. Therefore, for ease of description, the terms “software” and “firmware” may be interchangeably used hereinafter.

Herein, a process has a general meaning equivalent to that of a method, and does not necessarily correspond to the concept of computing process (which is the instance of a computer program being executed). More specifically, a process herein is a defined method implemented as software or firmware programs executable by hardware components for processing data (such as data received from users, other computing devices, other components of the computing device 752/754, and/or the like). A process may comprise or use one or more functions for processing data as designed. Herein, a function is a defined sub-process or sub-method for computing, calculating, or otherwise processing input data in a defined manner and generating or otherwise producing output data.

Alternatively, a process may be implemented as one or more hardware structures having necessary electrical and/or optical components, circuits, logic gates, integrated circuit (IC) chips, and/or the like.

Referring back to FIG. 19C, the application layer 782 comprises one or more application programs 784 executed by or performed by the processing structure 762 for performing various tasks.

The operating system 786 manages various hardware components of the computing device 752 or 754 via the logical I/O interface 788, manages the logical memory 792, and manages and supports the application programs 784. The operating system 786 is also in communication with other computing devices (not shown) via the network 758 to allow the application programs 784 to communicate with programs running on other computing devices. As those skilled in the art will appreciate, the operating system 786 may be any suitable operating system such as MICROSOFT® WINDOWS® (MICROSOFT and WINDOWS are registered trademarks of the Microsoft Corp., Redmond, WA, USA), APPLE® OS X, APPLE® iOS (APPLE is a registered trademark of Apple Inc., Cupertino, CA, USA), Linux, ANDROID® (ANDROID is a registered trademark of Google Inc., Mountain View, CA, USA), or the like. The computing devices 752 and 754 of the computer network system 750 may all have the same operating system, or may have different operating systems.

The logical I/O interface 788 comprises one or more device drivers 790 for communicating with respective input and output interfaces 770 and 772 for receiving data therefrom and sending data thereto. Received data may be sent to the application layer 782 for being processed by one or more application programs 784. Data generated by the application programs 784 may be sent to the logical I/O interface 788 for outputting to various output devices (via the output interface 772).

The logical memory 792 is a logical mapping of the physical memory 766 for facilitating the application programs 784 to access. In this embodiment, the logical memory 792 comprises a storage memory area that may be mapped to a non-volatile physical memory such as hard disks, solid-state disks, flash drives, and/or the like, generally for long-term data storage therein. The logical memory 792 also comprises a working memory area that is generally mapped to high-speed, and in some implementations, volatile physical memory such as RAM, generally for application programs 784 to temporarily store data during program execution. For example, an application program 784 may load data from the storage memory area into the working memory area, and may store data generated during its execution into the working memory area. The application program 784 may also store some data into the storage memory area as required or in response to a user's command.

In a server computer 752, the application layer 782 generally comprises one or more server-side application programs 784 which provide(s) server functions for managing network communication with client computing devices 754 and facilitating collaboration between the server computer 752 and the client computing devices 754. Herein, the term “server” may refer to a server computer 752 from a hardware point of view, or to a logical server from a software point of view, depending on the context.

As described above, the processing structure 762 is usually of no use without meaningful firmware and/or software. Similarly, while a cabling design system 750 may have the potential to perform various tasks, it cannot perform any tasks and is of no use without meaningful firmware and/or software. As will be described in more detail later, the cabling design system 750 described herein, as a combination of hardware and software, generally produces tangible results tied to the physical world, wherein the tangible results such as those described herein may lead to improvements to the computer and system themselves.

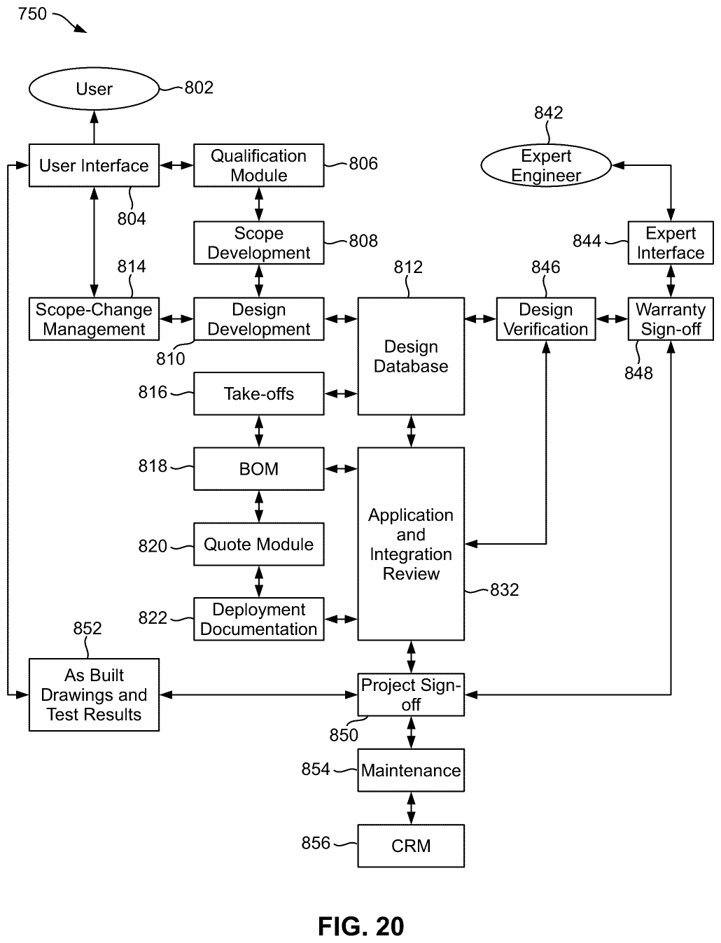

FIG. 20 is a schematic diagram showing the architecture modules of the cabling design system 750. The cabling design system 750 supports users 302 and expert engineers 822. Herein, a user 802 refers to the partners who provide information of the cabling project (for example, specifications and requirements for deploying cables in a building), and a qualified technician or engineer refers to partners who review and verify the cabling design. In various embodiments, the system 100 may comprise internal and external users who are governed by authorized access.

As shown, the cabling design system 750 comprises a user interface module 804 for user 802 to input information of the cabling project to start the design process, and to use as a prompt to guide the sales and project manager regarding the key information to be gathered during the initial discussions with the client. In some embodiments, the user interface module 804 provides a templated qualification questionnaire to facilitate the user to enter the information of the cabling project. The templated qualification questionnaire is designed to outline the requirements of the system such as new build or refurbished site, quantity of ports required, construction type (traditional or modular), special considerations for advanced network equipment, corporate standards that need to be met, and/or the like.

In some embodiments, the user interface 804 may also be used for user 802 to upload drawings from the design, client, and/or construction teams.

A qualification module 806 collects the user information of the cabling project which is then used by a scope development module 808 to define the scope of the cabling project based on the collected user information of the cabling project as discussions start to move from the end user requirements to the construction design. The defined scope of the cabling project outlines in-depth key information of the cabling project such as tray routes, site conditions that need to be considered, key deliverable dates, and/or the like.

Then, the defined scope of the cabling project is sent to the design development module 810 and to start the design of the cabling system. More specifically, the design development module 810 automatically cross-references the defined scope of the cabling project with information obtained from the design database 812 to ensure the designed cabling system is in compliance with to relevant code, standards, and best practices. In these embodiments, the design database 812 stores information and knowledge of code, standards, and best practices relevant to design of cabling systems, and may also store data of previously designed cabling system. The design database 812 may also control the integration with third-party applications such as industry-standard drawing packages for submissions and overlays.

Although not shown, the cabling design system 750 may also comprise an artificial intelligence (AI) engine linked to the design database 812 for identifying and advising on the best outcomes for all designs & take offs.

The design development module 810 may highlight any infractions on the design and give options for resolution based on the knowledge obtained from the design database 812, including, for example,
lengths that do not meet the maximum end-to-end data run;
conflicts with other services;
insufficient fill density of physical infrastructure (cable tray as an example).

If no infractions on the design are determined, the design development module 810 automatically generates or otherwise designs the cabling system based on the information received from the scope development module 808 and the information retrieved from the design database 812.

The design development module 810 also stores the information it generated (such as infractions, options for resolution, designed cabling system, and/or the like) into the design database 812.

In these embodiments, the cabling design system 750 comprises a scope-change management module 814 as a hub for keeping track of any design changes that happen during the entirety of the project. These changes are calculated for the impact to the original design and advice if there is a cost associated with this change or if it is a reallocation from the initial design that may not carry a charge with it. These changes are then sent back to the design development module 810 for adjusting the documentation as a revision to scope and making sure the most up-to-date and relevant information is available at all levels of the project. The scope-change management module 814 also reports the changes to the user 802 via the user interface 804.

After the design development (conducted by the design development module 810), a take-off module 816 may plot an optimal cabling design onto the floor plans of the building to produce accurate length and quantity drawings such as issued-for-construction (IFC) drawings, which is then stored in the design database 812. The take-off module 816 also provides necessary information to a bill of materials (BOM) module 818 so that the BOM module 818 uses the information received from the take-off module 816 to create the bill of materials showing all components and their details that are required to order products.

A quote module 820 applies the BOM information to generate accurate quotes for the sales team to submit to the party with signoff authority. The quote module 820 may provide customization options for the partner to adjust the quotes presentation to meet their requirements. These customizations may be saved as templates for future use.

With the quotes generated at the quote module 820 and the cabling design plots generated by the take-offs module 816, a deployment documentation module 822 then generates a full set of deployment documentation.

An application and integration review module 832 and/or a design verification module 846 collects data of the cabling project from the design database 812, the BOM module 818, and the deployment documentation module 822 to automatically review and verify the entire cabling design to confirm accuracy of the issued-for-construction (IFC) drawings and the deployment plan (generated by the deployment documentation module 822) for the project prior to them being produced, to ensure that:
all orders are received correctly;
the installation follows the designed parameters; and
all relevant information is available to the site leads.

In some embodiments, the system 100 may also allow manual verification (for example, by admin users and/or other authorized users).

The application and integration review module 832 ensures that all aspects of the designed cabling systems are accurate and in compliance with relevant standards. The application and integration review module 832 may also control the integration with third-party applications such as financial for ordering, project management tools for scheduling, and/or the like.

In these embodiments, the cabling design system 750 also comprises an expert interface 844 for expert engineer 842 to operate the design verification module 846 to facilitate the design review in the application and integration review module 832. The design verification module 846 also allows the expert engineer 842 to verify at key milestones of each project's life cycle to validate accuracy, design intent, compliance, and that the suitable methodology is being followed.

In these embodiments, each project must submit in full the as-built drawings and full test results to the expert engineer 842 for validation. The expert engineer 842 may attend site to do a final inspection of the physical installation. Ensuring that the correct installation methods have been followed and that product has not been damaged or tampered with in a way that would cause a warranty to not be issued. Then, the expert engineer 842 may use a warranty sign-off module 848 for sign-off.

In these embodiments, a project sign-off module 850 is used for relevant parties to sign-off the deployment of the cabling project at various stages. For example, plotted cabling design and the created BOM may be passed to the project sign-off module 850 for the client to signoff for ensuring the design meets the end-user intent.

Once the cabling system has been deployed and fully tested, the partner may upload as-builts via an as-built drawings and test results module 852 to show any deviations or changes due to site conditions that may have altered from the design IFC drawings during installation. The partner may also use the as-built drawings and test results module 852 to upload the full test results captured by industry standard test equipment (such as Fluke or equivalent). This information is then passed to the project sign-off module 850 for requesting warranty sign-off from expert engineer 842. Upon acceptance of the project a warranty will be issued for the system. The as-built drawings and test results may also be reported to user 802 via the user interface 804.

Once the project has received all sign-offs, the project is then transferred to the maintenance module 854 for compiling accurate dates and schedules for maintenance of the deployed system. This may include cross-reference of the documentation issued during the project sign-off phase, as well as an accurate timeline for the start to end of warranty period. This may also include any changes that happen to the signed-off cabling system due to moves, adds, or changes. This is important information that must be kept up to date.

Key metric information is then compiled by a customer relationship management (CRM) module 856 into a CRM report for easy reference from the sales teams as a reference for all designed, in-progress, and completed projects.

With above-described modules, the cabling design system 750 provides a comprehensive methodology for cabling design. The methodology includes one or more of:

1. SCOPE OF SOLUTION (SOS)—guiding the user in determining the smart-building requirements.
a. Intuitively leading the user through a comprehensive assessment of the currently planned system functional requirements, and taking into account all of the possible and future potential technologies and applications that may be relevant to their building operations.
b. Determining the user's desired level of scalability, interoperability, adaptability, and/or redundancy of the smart-building requirements.

2. EXPERT DESIGN ENGINE (EDE)—using the determined SOS, automatically producing a cabling design solution by applying best practice methodologies, standards and specifications that includes:
a. A complete BOM list with part numbers;
b. Cabling & smart building design drawings;
c. A virtual reality (VR) and 3D model for users to do a “virtual” walk through and sign off with their clients;
d. Cabling material price and a labor estimate (which may be location dependent);
e. Construction drawings as a deployment aid for technicians and construction managers; and/or
f. As-built drawings and budget versus actual analysis once installation is complete using application/data integration.

3. VALUE-ADDED APPLICATION INTEGRATION (VAI)—Integrating data from the cabling design system 750 with the cabling system 100 and/or customer-owned systems such as architecture, engineering and construction management, accounting, CRM, and/or the like, using open architecture application programming interfaces (APIs), wherein this integration may be both push and pull in function, pulling CRM, accounting, as-built and costing data to support the ADAPTIVE SOLUTIONS ENGINE (ASE) (see below), and wherein the integration may also include third-party application presentation within the user interface (UI) of the cabling design system 750.

4. MATERIALS LOGISTICS—Using the BOM output for client inventory stock allocation in readiness for manufacturing and shipping from the factory.

5. ADAPTIVE SOLUTIONS ENGINE (ASE)—Using the AI engine such as a machine-learning (ML) engine to continuously evolve the cabling design system 750 with improved capabilities and optimization performance of both the SOS and EDE, wherein the ML engine is an application layer running in parallel to other system modules to autonomously observe and recognize patterns and optimum solution profiles.

The ML engine is data dependent in that more data provides for better functionality in solution modelling. Therefore, initially the ML engine may improve exponentially as integrated data repositories are shared and more solution profiles are captured and analyzed such that the ML engine may highly automate the continual improvement of the solution capability of the application.

6. Cyber Security—As an integral function and responsibility of the cabling design system 750, providing security for users and systems to protect from potential malicious cyber-attacks, wherein the cabling design system 750 may include a robust cyber-security platform (including, for example a two-factor authentication requirement) in the backend or the server to protect users' data, third-party application connections, and all internal systems from potential cyber threats.

7. TRAINING, UPGRADES, MAINTENANCE & SUPPORT (TUMS)—Training on both the use of the cabling design system 750 and cabling design best practices, standards, and integration; leveraging user input to identify and prioritize application enhancements (UPGRADES); monitoring and managing the cabling design system 750 to ensure 99.99% uptime and timely response (MAINTENANCE); and providing advisory services on both the use of the cabling design system 750 and cabling design best practices, standards, and integration through various methods such as real-time chat and email support requests (SUPPORT).

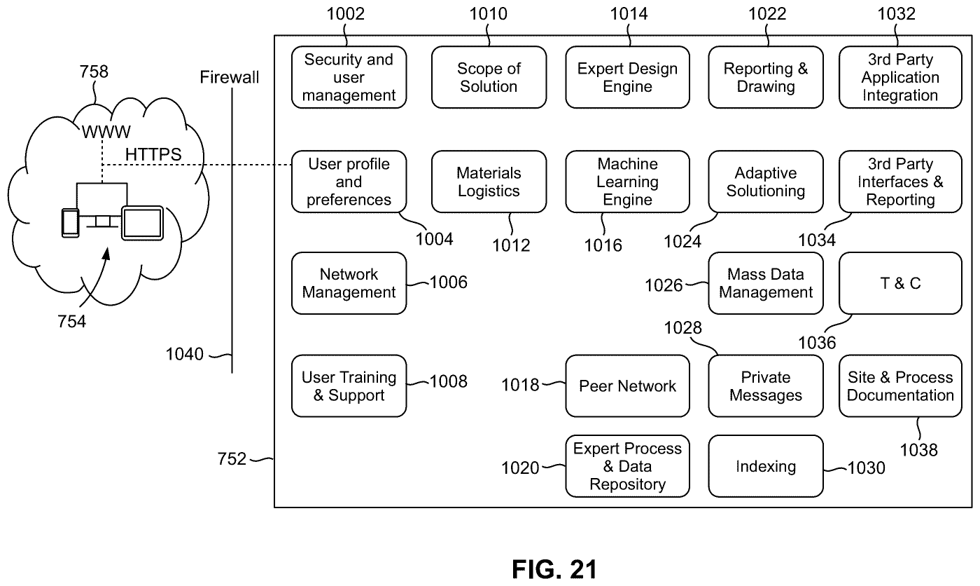

As shown in FIG. 21, with above-described methodology, the cabling design system 750, or more specifically, the one or more servers 752 thereof, may provide various functions such as:
security and user management function 1002 for providing cyber security and for managing users;
user profile and preferences function 1004 for managing user profile and preferences;
network management function 1006 for managing the network 758;
user training and support function 1008 for providing above-described training and support to users;
scope of solution function 1010 for determining the SOS as described above;
materials logistics function 1012 for managing materials logistics in deploying the cabling system 100 designed by the cabling design system 750;
expert design engine 1014 for performing evaluation and validation of scope and design;
machine-learning engine 1016 for optimizing the design of the cabling system 100;
peer network function 1018 (that is, communication interface for communicating with other computer and computing devices);
expert process & data repository 1020 for storing information used and/or generated by the cabling design system 750;
reporting and drawing function 1022 for generating reports and drawings of the cabling system 100;
adaptive solutioning function 1024 for adaptively providing cabling solutions based on user requirements;
mass data management function 1026 for managing mass data storage files (which are large-size files where many processes may retrieve data therefrom);
private messaging function 1028 for use between various users;
indexing function 1030 for indexing data stored in the expert process & data repository 1020;
third-party application integration function 1032 for providing integration of the cabling design system 750 with third-party applications;
third-party interfaces and reporting 1034 for interfacing with third-party applications and for generating reports for third-party applications;
terms and conditions (T&C) function 1036; and
site and process documentation function for automatically generating site and process documentation.

A user may use a client computing device 754 to access the one or more servers 752 via the network 758 and a firewall 1040 for using the above-described functions for cabling design.

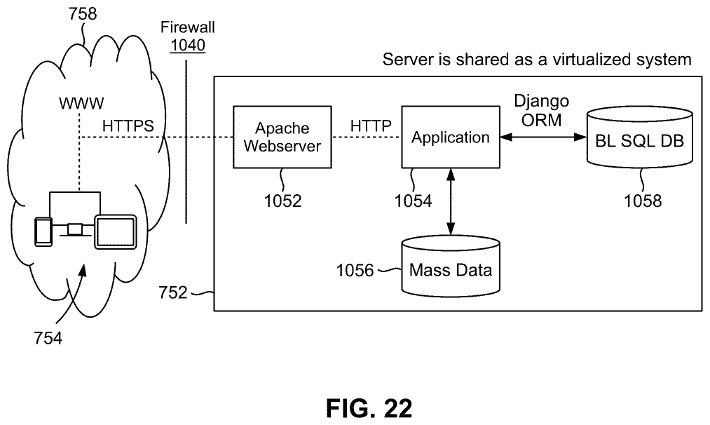

FIG. 22 is a schematic diagram showing an exemplary implementation of the functions shown in FIG. 21. As shown, one or more servers 752 may be shared as a virtualized system and execute a webserver 1052 such as an Apache webserver, a mass-data database 1058 for storing mass data, and a business logic (BL) SQL database 1056 for storing business logic & index files of the mass-data database 1058. The webserver 1052 comprises an application module 1054 that implements the above-described functions.

A user may use a client computing device 754 to query the webserver 1052 through the firewall 1040 using the hypertext transfer protocol secure (HTTPS) protocol. The webserver 1052 passes the query to the application module 1054 using the hypertext transfer protocol (HTTP) protocol, which performs necessary functions using data retrieved from the mass-data database 1056 and/or the BL SQL database 1058. The application module 1054 then sends the query results to the client computing device 754 via the webserver 1052.

Thus, the cabling design system 750 provides a complementary solution as a tool and aid to account partners who want to progress to smart IoT cabling but do not have the knowledge. The cabling design system 750 provides engineers and project technicians with the path to producing integrated smart IoT cabling designs based on industry standards and design practices. Automation of the cabling-design processes may simplify, optimize the design process and provide detailed plans for deployment.

The cabling design system 750 is suitable for various cabling design tasks such as enterprise cabling design, residential cabling design, and the like.

As those skilled in the art will appreciate, the cabling design system 750 may process entered project data and produce a full design package, thereby removing multiple touchpoints and reducing the turnaround time to produce documents for sales, procurement, and deployment teams.

The cabling design system 750 may produce accurate drawings and IoT cable lengths to ensure that the factory build list is specified accurately and error free.

The cabling design system 750 may identify and process 100% of the needs for a project from the data entered in order to produce the correct end results.

The cabling design system 750 replaces the manual methodology with an automated process which may optimize cable routes and produce a design package that meets 100% of IoT cabling standards and the needs of the end user. Such efficiencies result in cost savings for the account partner.

The cabling design system 750 may integrate third-party applications with stable and consistent two-way interaction that highlights potential conflicts within the design parameters.

The cabling design system 750 may implement all necessary security systems and protocols with positive results from ethical hacking tests and validation of the security effectiveness.

The cabling design system 750 may produce a real-time BOM for each project through the design process which enables effective material management through links to the warehouse and factory systems. The cabling design system 750 may provide accurate forecasting of inventory requirements to fulfil all customer orders on time effectively, thereby creating a smooth transition from factory to delivery with minimized delays and maximized profitability for account partners.

The cabling design system 750 may provide training and support as needed.

Although embodiments have been described above with reference to the accompanying drawings, those of skill in the art will appreciate that different embodiments may be combined as needed and/or desired. Moreover, variations and modifications may be made without departing from the scope thereof as defined by the appended claims.

What is claimed is:

1. An apparatus comprising:
a first flexible elongated body;
a plurality of cables extending in the first body along a lengthwise direction; and
a first connection assembly on a longitudinally first end of the first body connecting to the plurality of cables;
wherein each of the plurality of cables comprises a plurality of wires for transmitting signals and/or power to the first connection assembly.

2. The apparatus of claim 1, wherein the first connection assembly comprises:
a first housing; and
a plurality of first ports at fixed locations on or adjacent a distal end of the first housing;
wherein each first port of the plurality of first ports comprises a plurality of pins connecting to the plurality of wires of the cable that the first port is connected thereto.

3. The apparatus of claim 2, wherein each of the plurality of pins is an end portion of the corresponding wire.

4. The apparatus of claim 2, wherein the plurality of first ports are registered-jack-45 (RJ45) ports; and
wherein the plurality of cables are category (CAT) 5, CAT 5e, CAT6, CAT 6A, CAT 6e, CAT 7, and/or CAT 8 cables.

5. The apparatus of claim 2, wherein the plurality of first ports are arranged in a matrix form.

6. The apparatus of claim 1, wherein each of the plurality of cables comprises:
a flexible, elongated jacket; and
a noise-reduction shield received in the jacket;
wherein the plurality of wires are received in the shield.

7. The apparatus of claim 1 further comprising:
a second connection assembly on a longitudinally second end of the first body connecting to the plurality of cables, the second end being longitudinally opposite to the first end;
wherein the plurality of wires of each of the plurality of cables are for transmitting signals and/or power between the first and second connection assemblies.

8. The apparatus of claim 7, wherein the second connection assembly comprises:
a second housing; and
a plurality of second ports at fixed locations on or adjacent a distal end of the second housing;
wherein each second port of the plurality of second ports comprises a plurality of pins connecting to the plurality of wires of the cable that the second port is connected thereto.

9. The apparatus of claim 7, wherein the second connection assembly comprises:
a second housing; and
a plurality of pin holes at fixed locations on or adjacent a distal end of the second housing;
wherein each of the plurality of pin holes comprises an electrically conductive pin sleeve received therein and connecting to one of the plurality of wires of the plurality of cables.

10. A panel comprising:
a plurality of ports arranged in groups for connecting a group of connection ports to one of the first and second connection assemblies of the apparatus of claim 1.

11. The panel of claim 10, wherein a distance between neighboring groups is greater than a distance between neighboring connection ports.

12. A cable system comprising:
a plurality of the apparatuses of claim 1, deployed in a site; and
one or more panels each for connecting one or more of the plurality of the apparatuses;
wherein each of the one or more panels comprises:
a plurality of ports arranged in groups for connecting a group of connection ports to one of the first and second connection assemblies of a respective one of the plurality of the apparatuses of claim 1.

13. The cable system of claim 12 further comprising:
a component cable assembly comprising:
a second elongated flexible body, and
a pair of connectors coupled to two opposite ends of the second body;
wherein the second body has same electrical specifications as those of the first body, except length-related electrical specifications.

14. The cable system of claim 13, wherein the pair of connectors comprise a female RJ45 connector and a male RJ45 connector.

15. The cable system of claim 13, wherein the electrical specifications comprise:
number and specifications of wires in the second body;
manner of twisting of the wires in the second body; and
noise-reduction shield in the second body.

16. The cable system of claim 12, wherein the second body has same mechanical specifications as those of the first body, except length-related mechanical specifications.

17. A cable-pulling sled comprising:
a head housing; and
a retention strap extending rearwardly from the head housing;
wherein the head housing comprises:
a base,
a wall extending upwardly along the peripheral of the base, and
a plurality of tie-downs extending upwardly from the base for retaining a plurality of cabling apparatuses to the base; and
wherein the plurality of tie-downs are at locations of the base such that head connectors of the plurality of cabling apparatuses are arranged in a zig-zag manner on the base.

18. The cable-pulling sled of claim 17 further comprising:
a handle extends forwardly from a front portion of the wall.

19. The cable-pulling sled of claim 18, wherein the handle comprises a hole.

20. The cable-pulling sled of claim 17, wherein the retention strap comprises a plurality of strings for securing plurality of cabling apparatuses to the retention strap.
